(19) United States
(12) Patent Application Publication
(10) Pub. No.: US 2017/0264984 A1
(43) Pub. Date: Sep. 14, 2017

(54) Headphone System And Components Thereof

(71) Applicant: Princeton Audio, LLC, Princeton, WI (US)

(72) Inventor: Michael J. Pelland, Princeton, WI (US)

(73) Assignee: Princeton Audio, LLC, Princeton, WI (US)

(21) Appl. No.: 15/456,088

(22) Filed: Mar. 10, 2017

Related U.S. Application Data
(60) Provisional application No. 62/306,267, filed on Mar. 10, 2016.

(51) Int. Cl. H04R 1/06; H04R 1/10

(52) U.S. Cl. CPC H04R 1/06; H04R 1/1008; H04R 1/1025; H04R 1/105; H04R 2420/09; H04R 2420/07

(57) ABSTRACT

Headphone assemblies, related components such as headband assemblies and ear cup assemblies, and methods of operation and assembly are disclosed herein. Some of the headphone assemblies include a headband assembly and a first and second ear cup assembly, the ear cup assemblies having attachment mechanisms adapted to reversibly mate with counterpart attachment mechanisms in the headband assembly such that the ear cup assemblies can each be readily replaced or exchanged, and such that each ear cup assembly connects mechanically and electrically to the headband assembly. Some of the headphone assemblies include one or more cambering features that cause an attachment mechanism on the headphone assembly, or a first reference plane defined by an inwardly-facing surface of the first ear cup assembly, to change its orientation relative to the headband assembly or a first arm thereof, in response to pivotal or extensible articulation of the headband assembly over a range of motion.

### CROSS-REFERENCE TO RELATED APPLICATIONS

This application claims priority under 35 U.S.C. §119(e) to pending provisional patent application U.S. Ser. No. 62/306,267, “Headphone System and Components Thereof”, filed Mar. 10, 2016, the contents of which are incorporated by reference.

### FIELD OF THE INVENTION

The present invention relates to audio systems and methods, and in particular, to headphone systems, related components, and methods of operation and assembly.

### BACKGROUND OF THE INVENTION

A variety of headphone systems exist on the market today. Notwithstanding the many headphone systems in existence, many conventional headphone systems suffer from one or more concerns or disadvantages. Among other things, users wearing headphone systems on their heads can experience “headphone fatigue” if the headphone systems are not positioned in desirable manners upon their heads, or after long periods of usage of the headphone systems. Also, users can experience circumstances in which a given headphone system, although suitable for a particular user or a particular use, is not suitable for that user at a later time, or is not suitable for another user or for another use.

Therefore, it would be advantageous if an improved headphone system, or one or more components thereof, or methods of operation or assembly pertaining thereto, could be developed that would alleviate one or more of the above-discussed concerns or disadvantages or other concerns or disadvantages, or that would achieve one or more benefits.

### SUMMARY OF THE INVENTION

We disclose herein headphone assemblies, related components such as headband assemblies and ear cup assemblies, and methods of operation and assembly, with new features and new combinations of features. Some of the headphone assemblies include a headband assembly and a first and second ear cup assembly, the ear cup assemblies having attachment mechanisms adapted to reversibly mate with counterpart attachment mechanisms in the headband assembly such that the ear cup assemblies can each be readily replaced or exchanged, and such that each ear cup assembly connects mechanically and electrically to the headband assembly. Some of the headphone assemblies include one or more cambering features that cause an attachment mechanism on the headphone assembly, or a reference plane defined by an inwardly-facing surface of the first ear cup assembly, to change its orientation relative to the headband assembly or a first arm thereof, in response to pivotal or extensible articulation of the headband assembly over a range of motion.

We also disclose headband assemblies for use in headphones, where the headband assembly includes an electronics section, a battery section electrically coupled to the electronics section, a first headband attachment mechanism disposed at a first end of the headband assembly, and a second headband attachment mechanism disposed at a second end of the headband assembly, the second end being opposed to the first end of the headband assembly. Each of the first and second headband attachment mechanisms may be configured to detachably connect to an ear cup assembly and provide an electrical connection from the ear cup assembly to the electronics section.

The electronics section may include one or more electronic components such as a microprocessor, an amplifier, and an antenna. The battery section may be wired to energize at least one of the one or more electronic components when a suitable battery is present in the battery section. The electronics section and the battery section may be disposed in separate compartments on or in the headband assembly, or they may instead be disposed in a same compartment on or in the headband assembly. The first headband attachment mechanism may include a first male or female multi-pin electrical connector, and the second headband attachment mechanism may include a second male or female multi-pin electrical connector. The headband assembly may include a C-shaped main headband body and a first and second arm extending from opposite ends of the main headband body, the main headband body including the electronics section and the battery section, the first arm including the first headband attachment mechanism, and the second atm including the second headband attachment mechanism, and the headband assembly may further include: one or more first cambering features that cause the first headband attachment mechanism to change its orientation relative to the first arm in response to pivotal or extensible articulation of the headband assembly over a range of motion; and one or more second cambering features that cause the second headband attachment mechanism to change its orientation relative to the second arm in response to the pivotal or extensible articulation of the headband assembly over the range of motion.

A rotational axis may pass through the first and second headband attachment mechanisms, and the one or more first cambering features may cause the first headband attachment mechanism to rotate about a first secondary axis in response to pivotal articulation of the headband assembly about the rotational axis, and the one or more second cambering features may cause the second headband attachment mechanism to rotate about a second secondary axis in response to the pivotal articulation of the headband assembly, the first and second secondary axes each being perpendicular to the rotational axis. The first and second arms may slidingly engage the main headband body to provide extensible articulation of the headband assembly between an extended configuration and a retracted configuration, and the one or more first cambering features may cause the first headband attachment mechanism to change its orientation relative to the first atm in response to the extensible articulation, and the one or more second cambering features may cause the second headband attachment mechanism to change its orientation relative to the second arm in response to the extensible articulation.

The headband assembly may be combined with a first and second earcup assembly to provide a headphone assembly, where the first ear cup assembly detachably connects to the first headband attachment mechanism, and the second ear cup assembly detachably connects to the second headband attachment mechanism. The first headband attachment mechanism may include a first male (or female) multi-pin electrical connector, and the first ear cup assembly may include a first female (or male) multi-pin electrical connector that reversibly mates with the first male (or female) multi-pin electrical connector.

We also disclose headphone assemblies that include a headband assembly and a first and second ear cup assembly. The headband assembly may include an electronics section, a battery section electrically coupled to the electronics section, and a first and second headband attachment mechanism. The first ear cup assembly may have a first ear cup attachment mechanism adapted to reversibly mate with the first headband attachment mechanism to mechanically and electrically connect the first ear cup assembly to the headband assembly. The second ear cup assembly may have a second ear cup attachment mechanism adapted to reversibly mate with the second headband attachment mechanism to mechanically and electrically connect the second ear cup assembly to the headband assembly.

The first and second ear cup assemblies may rotationally engage the headband assembly to provide rotational articulation of the headband assembly over a rotational range of motion from an over-head configuration to a behind-head configuration. The headband assembly may include a C-shaped main headband body and a first and second arm extending from opposite ends of the main headband body, the main headband body including the electronics section and the battery section. The first and second arms may slidably engage the main headband body to provide extensible articulation of the headband assembly over a translational range of motion from a fully extended configuration to a fully retracted configuration. The first arm may include the first headband attachment mechanism, and the second arm may include the second headband attachment mechanism, and the first and second ear cup assemblies may have a respective first and second inwardly-facing surface that define a respective first and second reference plane. The headband assembly may also include: one or more first cambering features that cause the first reference plane to change its orientation relative to the first arm in response to pivotal or extensible articulation of the headband assembly over a range of motion; and one or more second cambering features that cause the second reference plane to change its orientation relative to the second arm in response to the pivotal or extensible articulation of the headband assembly over the range of motion. The headband assembly may also include an inductive coil coupling section coupled to the battery section.

We also disclose headphone assemblies that include a headband assembly, a first earcup assembly, and a second earcup assembly. The headband assembly has a first arm and a second arm arranged for placement on opposite sides of a user's head. The first ear cup assembly and the second ear cup assembly are connected to the headband assembly by the first and second arms, respectively, the first and second ear cup assemblies having a respective first and second inwardly-facing surface that define a respective first and second reference plane. One or both of the first arm and the first ear cup assembly may include one or more first cambering features that cause the first reference plane to change its orientation relative to the first arm in response to pivotal or extensible articulation of the headband assembly over a range of motion.

One or both of the second arm and the second ear cup assembly may include one or more second cambering features that cause the second reference plane to change its orientation relative to the second arm in response to pivotal or extensible articulation of the headband assembly over a range of motion. The one or more first cambering features may cause the first reference plane to change its orientation relative to the first arm in response to pivotal articulation of the headband assembly over an angular range of motion. The one or more first cambering features may also or alternatively cause the first reference plane to change its orientation relative to the first arm in response to extensible articulation of the headband assembly over a translational range of motion. The first ear cup assembly may detachably connect to the first arm by a first male/female multi-pin connector pair, and the second ear cup assembly may detachably connect to the second arm by a second male/female multi-pin connector pair.

We also disclose headphone assemblies that include a headband assembly having first and second end portions, and first and second ear cup assemblies respectively coupled at least indirectly to the first and second end portions, respectively. One or more of the end portions and ear cup assemblies includes one or more cambering features and, due to the cambering features, pivotal or extensible articulation of the headband assembly over a range of motion, such as a first rotation of the headband assembly relative to a rotational axis extending through one or both of the ear cup assemblies, causes the first ear cup assembly to rotate further about a secondary axis that is at least substantially perpendicular to the rotational axis, or causes the first ear cup assembly to otherwise change its orientation relative to the headband assembly or an arm or other portion thereof.

We also disclose headphone assemblies that include a headband assembly, a first ear cup assembly, and a second ear cup assembly. The headband assembly may include an electronics section, a battery section, and a first and second headband attachment mechanism. The first ear cup assembly may have a first ear cup attachment mechanism by which the first ear cup assembly is coupled to the first headband attachment mechanism, and the second ear cup assembly may have a second ear cup attachment mechanism by which the second ear cup assembly is coupled to the second headband attachment mechanism. The first and second ear cup attachment mechanisms and first and second headband attachment mechanisms may be configured to allow each of the first and second ear cup assemblies to be disassembled from, or readily detached from, the headband assembly, thus allowing for first and second replacement cup assemblies to be coupled to the headband assembly in place of the first and second ear cup assemblies.

We also disclose headband assemblies for implementation in headphone assemblies, where the headband assembly includes an electronics section, a battery section, and first and second headband attachment mechanisms. The first headband attachment mechanism may be configured to allow a plurality of first ear cup assemblies to be interchangeably coupled to the headband assembly, and the second headband attachment mechanism may be configured to allow a plurality of second ear cup assemblies to be interchangeably coupled to the headband assembly.

Notwithstanding the above descriptions, the present invention is intended to encompass a variety of other embodiments, including embodiments described in further detail below, and other embodiments that are within the scope of the claims set forth herein.

### BRIEF DESCRIPTION OF THE DRAWINGS

Embodiments of the disclosure are disclosed with reference to the accompanying drawings and are for illustrative purposes only. The disclosure is not limited in its application to the details of construction or the arrangement of the components illustrated in the drawings. The disclosure is capable of other embodiments, and of being practiced or carried out in other various ways. In the drawings:

FIG. 1 is a front elevation view of a headphone assembly in accordance with one example embodiment disclosed herein, where a headband assembly of the headphone assembly is in an over-head position;

FIG. 2 is the front elevation view of the headphone assembly of FIG. 1 positioned in relation to a user's head;

FIG. 3 is a right side elevation view of the headphone assembly and user's head shown in FIG. 2;

FIG. 4 is a front elevation view of the headphone assembly of FIG. 1, where the headband assembly of the headphone assembly is in a behind-head (or rearward-oriented) position;

FIG. 5 is a right side elevation view of the headphone assembly and user's head of FIGS. 2 and 3, where the headband assembly of the headphone assembly is in the behind-head (or rearward-oriented) position of FIG. 4;

FIG. 6 is a right side elevation view of the headphone assembly and user's head of FIGS. 2, 3, and 5, where the headband assembly of the headphone assembly is in an intermediate position, between the over-head position of FIGS. 1, 2, and 3 and the behind-head (or rearward-oriented) position of FIGS. 4 and 5;

FIG. 7 is a right side perspective cutaway view of a portion of the headphone assembly of FIG. 1 including a first ear cup assembly thereof, which illustrates components of the headphone assembly that facilitate cambering of that ear cup assembly of the headphone assembly;

FIG. 8 is an exploded front elevation view of the headphone assembly of FIGS. 1-7, with the first ear cup assembly of the headphone assembly shown to be exploded from the headband assembly and a second ear cup assembly of the headphone assembly removed completely from the headband assembly (and not shown);

FIGS. 9A, 9B, and 9C respectively are top perspective, front elevation, and right side elevation views, respectively, of the headband assembly of the headphone assembly of FIGS. 1-8;

FIGS. 10A, 10B, 10C, 10D, and 10E respectively are top plan, top perspective, left side elevation, rear elevation, and right side elevation views, respectively, of the first ear cup assembly of the headphone assembly of FIGS. 1-8;

FIG. 11 shows a partly perspective, cutaway, cross-sectional view of a portion of the headphone assembly of FIGS. 1-8 showing certain internal features of the headband assembly and first ear cup assembly;

FIGS. 12A, 12B, 12C, 12D, and 12E are top plan, top perspective, left side elevation, rear elevation, and right side elevation views, respectively, of an alternate ear cup assembly that can be utilized in conjunction with the headband assembly of FIGS. 1-9C and 11 instead of the first ear cup assembly of FIGS. 1-8 and 10A-10E;

FIG. 12F shows the top plan and left side elevation views of the ear cup assemblies of FIGS. 10A, 10C, 12A, and 12C side-by-side one another;

FIG. 13 is a perspective view of another headphone assembly, where one atm member of the headband assembly and one of the ear cup assemblies are omitted from the drawing for reduced clutter and ease of explanation;

FIGS. 14A and 14B are front elevation views of a headband assembly similar to that shown in FIG. 13, where one arm member is omitted for ease of explanation, the headband assembly shown in an extended configuration in FIG. 14A, and a retracted configuration in FIG. 14B;

FIGS. 14C and 14D are top elevation views of the headband assembly of FIGS. 14A and 14B, the headband assembly shown in an extended configuration in FIG. 14C, and a retracted configuration in FIG. 14D;

FIG. 15 is a perspective view of a female multi-pin electrical connector for use in the disclosed headphone assemblies to facilitate detachable connection of an ear cup assembly to a headband assembly, and FIG. 16 is a perspective view of the male counterpart of such female connector; and

FIG. 17 is a system block diagram of a headphone assembly and illustrative subassemblies and components thereof.

In the figures, like reference numerals designate like elements.

### DETAILED DESCRIPTION OF ILLUSTRATIVE EMBODIMENTS

The present inventor has recognized that improved headphone systems or assemblies can have one or more of several advantageous features. In at least some disclosed embodiments, the improved headphone assembly has an articulating headphone design with cambering ear cups. In some such embodiments, as the headband of the headphone is rotated from a position extending over the top of a user's head to a position behind the user's head (or vice-versa), the ear cups are cambered relative to the headband. That is, the angular positioning of the ear cups relative to the headband is adjusted about axes that are substantially perpendicular to a rotational axis of the headband. The headphone can also or alternatively be configured such that the cambering of the ear cups relative to the headband occurs in response to extensible articulation of the headband assembly between an extended configuration and a retracted configuration. In at least some embodiments, the headphone assembly employs an electronics-on-headband design that allows for removable and interchangeable ear cups. In some such embodiments, all or substantially all electrical components (e.g., aside from speaker components and associated wiring and electrical connectors) may be situated on the headband rather than on the ear cups, such that the ear cups themselves can be more easily removed and replaced, and the ear cups can be relatively inexpensive components in terms of their replacement cost. In alternative embodiments, some electrical components (such as microprocessor(s), amplifier(s), or other active electronic components that require electrical power to operate, or even passive electronic components other than simple wiring) may be included in the headband assembly, and other such components can be included one or both of the ear cup assemblies. In some embodiments, the headphone assembly may employ one or more ear cups that have easy-to-remove and replace ear cushions, and also internal cord management features.

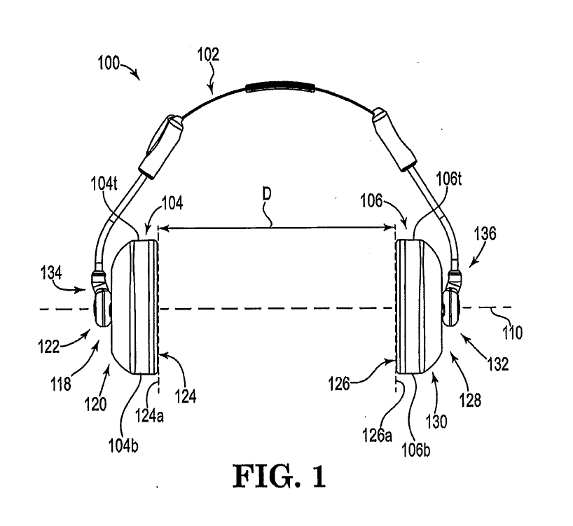

Referring to FIG. 1, a front elevation view is provided of an example headphone assembly 100. The headphone assembly 100 includes a headband assembly 102 and first and second ear cup assemblies 104 and 106, respectively. As will be described in further detail below, each of the ear cup assemblies 104 and 106 is attached to the headband assembly 102 via a particular coupling (or interaction) mechanism that includes a headband attachment mechanism and an ear cup attachment mechanism. The coupling mechanism is electro-mechanical in nature, in that it provides both mechanical attachment of the respective ear cup assemblies 104, 106 to the headband assembly 102, and electrical coupling of the respective ear cup assemblies 104, 106 to the headband assembly. Further, the coupling mechanism can be configured so that, as the headband assembly 102 articulates extensibly (e.g. between an extended configuration and a retracted configuration) or pivotally (e.g. rotated relative to the ear cup assemblies 104, 106 (or vice-versa) between an over-head configuration and a behind-head configuration), cambering or pivoting of the ear cup assemblies occurs. The coupling mechanism can also include features allowing for the headband assembly 102 to rest in certain intermediate positions as the headband assembly transverses its range of motion.

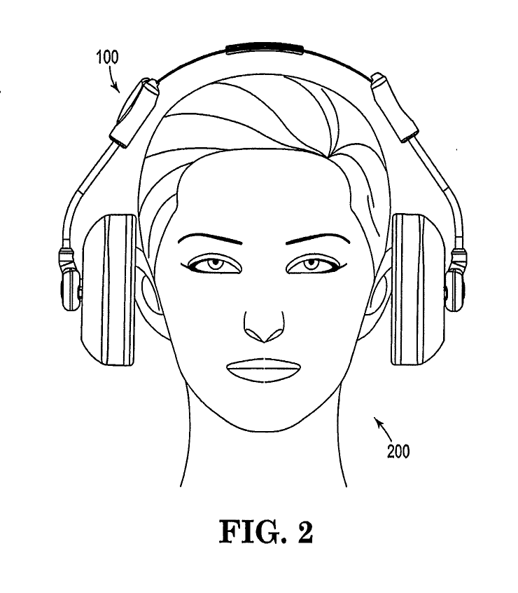

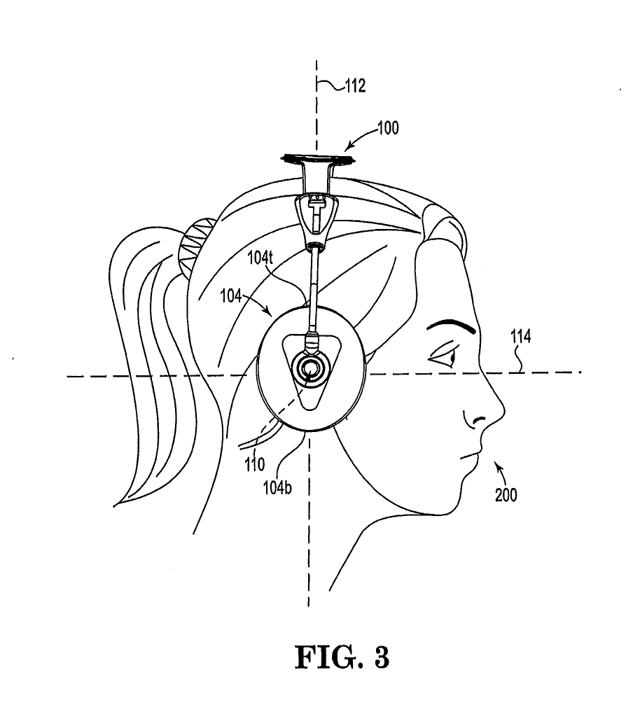

The headphone assembly 100 is designed and adapted for use with human heads, and may include known adjustment features allowing it to fit comfortably on heads of different sizes and shapes. FIG. 1 shows a front elevation view of the headphone assembly 100 when the headband assembly is in an over-head position, apart from any user being present. By comparison, FIGS. 2 and 3 respectively show front elevation and right side elevation views, respectively, of the headphone assembly 100 when it is mounted upon and in position about a head 200 of a user. As is evident for example from FIG. 3, each of the first and second ear cup assemblies 104 and 106 respectively may be oval or otherwise elongated in shape, in terms of first and second inwardly-facing surfaces 124 and 126 (see FIG. 1) of the respective ear cup assemblies that will face or contact the ears of a user when the headphone assembly 100 is being worn on a user's head. Thus, each of the first and second inwardly-facing surfaces 124, 126 of the ear cup assemblies 104, 106 may have a longer dimension, i.e., a major transverse dimension, and a shorter dimension, i.e., a minor transverse dimension. The inwardly-facing surfaces 124, 126 also lie in or otherwise define reference planes 124a, 126a, respectively, as shown, which can be used for convenience to characterize the orientation of the respective ear cup assemblies 104, 106 relative to the user's head or to other portions of the headphone assembly.

FIG. 3 illustrates standard positioning of the ear cup assemblies 104, 106 (only the first ear cup assembly 104 can be seen in this view) relative to the head 200 of a user. That is, standard positioning of the respective ear cup assemblies 104, 106 is positioning where the major dimension of the inwardly-facing surfaces 124, 126 of the respective ear cup assemblies is substantially parallel to the direction of a line extending between the bottom and top of the user's head 200, and the minor dimension of the respective inwardly-facing surfaces is parallel to another line extending between the front and rear of the user's head, substantially perpendicular to the major dimension. When the ear cup assemblies 104, 106 assume their standard positioning, a plane 112 defined by the major dimensions of the ear cup assemblies is arranged as shown in FIG. 3.

For reference purposes, we may designate opposite ends of each ear cup assembly as a top and bottom. In the standard position just described, the top and bottom of a given ear cup assembly are usually located at opposite ends of the major dimension of the inwardly-facing surface of such ear cup assembly. The top and bottom of each given ear cup assembly are, in this standard position, substantially aligned or similarly oriented as the top and bottom of the user's head. Accordingly, FIGS. 1 and 3 and other figures that follow, the top of the first ear cup assembly 104 is labeled 104t, and the bottom is labeled 104b, while the top of the second ear cup assembly 106 is labeled 106t, and the bottom is labeled 106b.

For the purposes of FIGS. 1, 2, and 3, an over-head position is a position of the headphone assembly 100 in which the headband assembly 102 of the headphone assembly extends in a manner relative to the ear cup assemblies 104, 106 that would be appropriate if a user was wearing the headphone assembly on his or her head and the headband assembly 102 extended around and over the top of the user's head, from one of the user's ears to the other of the user's ears. This position is one in which the headband assembly 102 substantially extends along (or within) the plane 112, with the ear cup assemblies 104, 106 in their standard positions as defined above.

Often, the over-head position corresponds to an arrangement in which the headband assembly 102 extends vertically upward from one of the ear cup assemblies 104 or 106 and then back vertically downward to the other of the ear cup assemblies, with the vertical directions upward or downward pointing away from or toward earth ground and aligned with the direction of gravity. This is the case when the headphone assembly 100 is positioned on the head 102 of a user who is standing or sitting with normal (not prostrate) posture such that the user's eyes are directed outward from the user's head in a horizontal manner. Nevertheless, the over-head position of the headphone assembly 100 need not always involve the headband assembly 102 extending vertically upward and downward relative to the ear cup assemblies 104, 106. For example, the over-head position would instead involve the headband assembly 102 extending horizontally if the headband assembly was worn on the head of a user who was lying down prostrate.

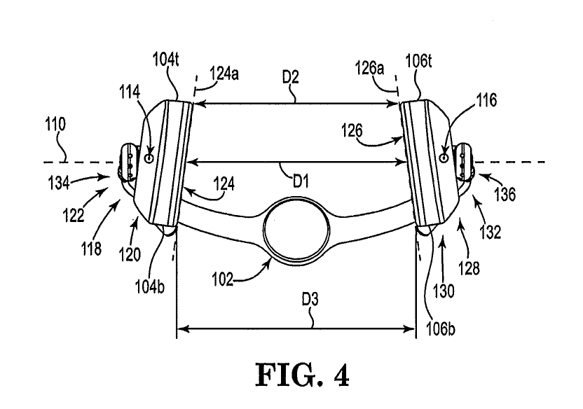

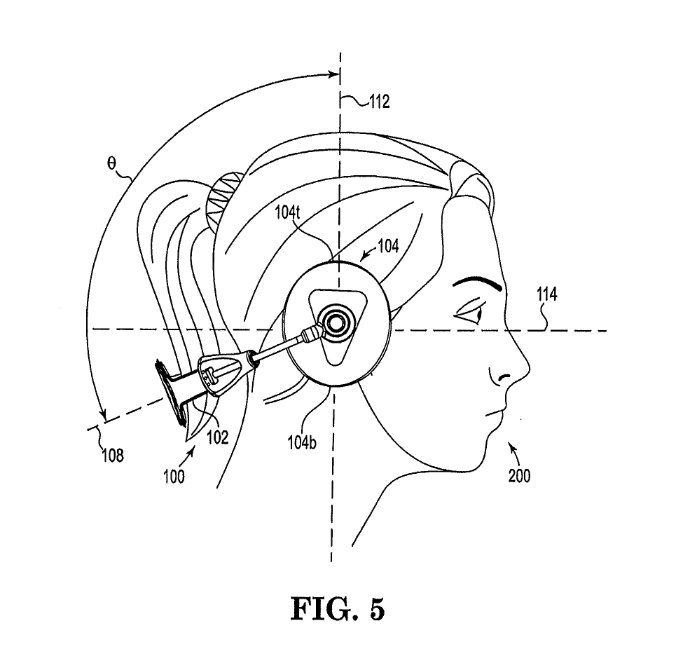

Turning to FIG. 4, there is provided a front elevation view of the headphone assembly 100 when the headband assembly 102 is in a behind-head (rearward-oriented) position, apart from any user being present. By comparison, FIG. 5 is a right side elevation view of the headphone assembly 100 when it is mounted upon the head 200 of a user and when the headband assembly 102 is in the same behind-head position as shown in FIG. 4. For purposes of FIGS. 4 and 5, a behind-head position is a position of the headphone assembly 100 in which the headband assembly 102 of the headphone assembly extends in a manner relative to the ear cup assemblies 104, 106 (when positioned in their standard positions as defined above) that would be appropriate if a user was wearing the headphone assembly on his or her head and the headband assembly 102 extended around the back of the user's head or upper neck, from one of the user's ears to the other of the user's ears. Thus, as shown in FIG. 5, the behind-head position is a position of the headphone assembly 100 in which the headband assembly 102 is rotated relative to the plane 112 (and thus rotated relative to the major dimensions of the ear cup assemblies 104, 106 when in their standard positions as defined above) by an amount equaling, substantially equaling, or relatively close to 90 degrees. The rotation can be measured by an angle θ formed between the plane 112 and another plane 108 as shown in FIG. 5, the plane 108 being the plane in which the headband assembly 102 resides, or along which it extends.

Although the behind-head position can in some cases be a position in which the angle θ between the headband assembly 102 (or its associated plane 108) and the plane 112 is exactly 90 degrees, this need not always be the case. Rather, as illustrated by FIG. 5, in at least some cases, the behind-head position can involve the headband assembly 102, and its associated plane 108, being rotated by an angle θ more than 90 degrees (e.g., 110 degrees) relative to the plane 112. Further, in some cases, the behind-head position can involve the rotation angle θ being less than 90 degrees (e.g., 75 degrees).

The over-head position need not necessarily be a position in which the headband assembly 102 extends vertically upward from one of the ear cup assemblies 104, 106 and then vertically downward back to the other of the ear cup assemblies, relative to earth ground (or the direction of gravity), and likewise the behind-head position need not necessarily be a position in which the headband assembly extends horizontally rearward from one of the ear cup assemblies and then horizontally forward back to the other of the ear cup assemblies, relative to earth ground. Rather, the exact nature of the over-head position and the behind-head position relative to earth ground or any other reference point can depend upon the embodiment or implementation, as well as whether the headphone assembly 100 is positioned on a user's head and the current position of the user's head.

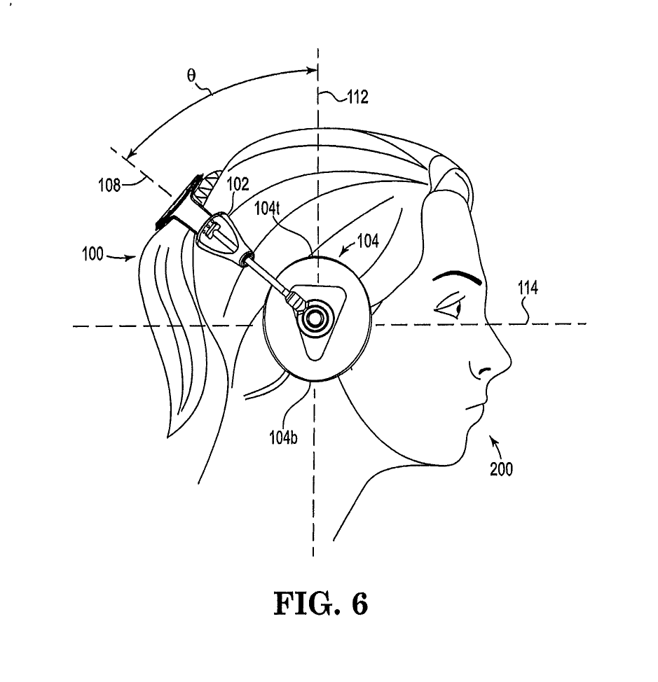

The reader will therefore appreciate that the headphone assembly 100 can be pivotally articulated or modified in configuration between the over-head and behind-head configurations or positions by rotating the headband assembly 102, and its associated reference plane 108, relative to the plane 112 of the major dimensions of the two ear cup assemblies 104, 106, as shown for example in FIG. 5. The headphone assembly 100 can have not only the over-head and behind-head configurations or positions corresponding to (at least in some cases) the outermost rotational positions or end points of the headband assembly 102, but also can take on intermediate positions between those end points. The over-head position of FIGS. 1-3, and the behind-head position of FIGS. 4-5, show exemplary resting positions or resting places for the headband assembly 102, but the disclosed headband assemblies may take other positions or configurations as well. In this regard, FIG. 6 shows the headphone assembly 100 in an intermediate position that involves rotation of the headband assembly 102, and its associated reference plane 108, at an angle θ of about 60 degrees relative to the plane 112 and to the position of the headband assembly when in the over-head position.

The positioning, and change in configuration, of the headphone assembly 100 involves rotational movement of the headband assembly 102 relative to the ear cup assemblies 104, 106, which may remain fixed in their rotational position relative to a rotational axis 110 extending between center points of the ear cup assemblies as shown in FIGS. 1 and 3 (e.g., remain fixed in their standard positions as defined above), notwithstanding rotation of the headband assembly about that rotational axis. Although the ear cup assemblies 104, 106 do not rotate about the rotational axis 110 when this pivotal articulation of the headband assembly 102 is occurring—for example, because (or as if) the ear cup assemblies are in frictional contact with the ears of a user's head that precludes such rotation—the ear cup assemblies 104, 106 may experience a different type of rotation when the headphone assembly 100 (and the headband assembly 102) position is modified. This different type of rotation is referred to herein as cambering.

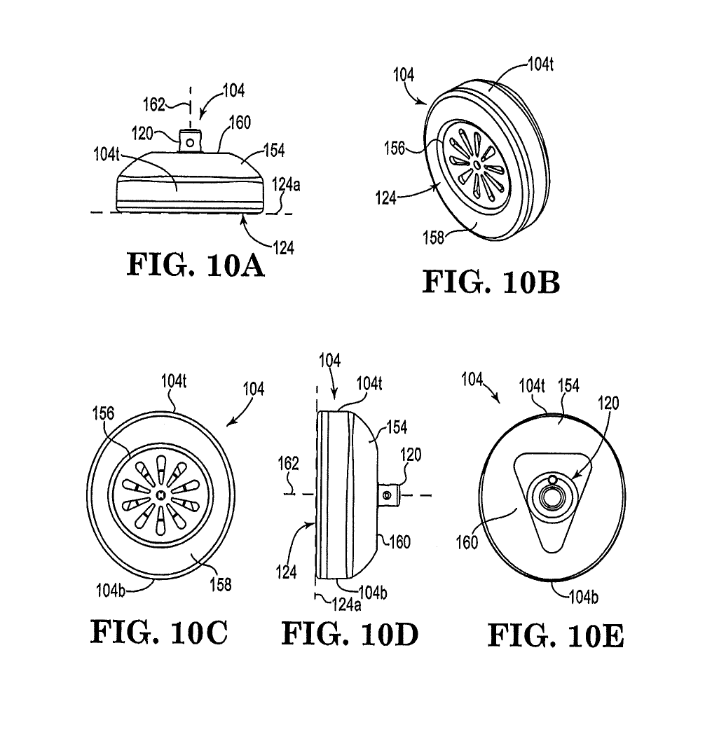

By comparing FIGS. 1, 3, 4, and 5, one can see that the first and second ear cup assemblies 104, 106 respectively are capable of experiencing self-induced rotation about first and second coupling axes 114 and 116, respectively, which may also be considered to be secondary rotational axes. The rotation may be said to be self-induced insofar as it results from forces between different components or elements of the headphone assembly rather than forces between the user's head and the headphone assembly. The coupling axes 114, 116 may each extend perpendicularly (or substantially perpendicularly) relative to the plane 112, and relative to the rotational axis 110, which in the present embodiment is also intersected by each of the coupling axes 114, 116. FIGS. 1 and 4 show how the first and second ear cup assemblies 104, 106 take on different rotational positions about the coupling axes 114, 116 depending upon the positioning of the headphone assembly 100 and of the headband assembly 102 relative to the ear cup assemblies. As shown in FIG. 1, when the headphone assembly 100 is in the over-head position or configuration, both the first and second ear cup assemblies 104, 106 may be untilted relative to the rotational axis 110. That is, central axes of each of the first and second ear cup assemblies 104, 106 (e.g., including a central axis 162 of the first ear cup assembly 104 shown in FIGS. 10A and 10D) may be fully aligned with and coincide with the rotational axis 110. When in this position, the first and second inwardly-facing surfaces 124 and 126, and their associated reference planes 124a, 126a, are perpendicular to the rotational axis 110 and parallel (e.g., substantially parallel) to each other, such that all pairs of corresponding locations or points on the two inwardly-facing surfaces 124, 126 (or their associated reference planes) are separated by a constant distance D, as shown in FIG. 1.

By contrast, as shown in FIG. 4, when the headphone assembly 100 is in the behind-head position or configuration, each of the first and second ear cup assemblies 104 and 106 is in a cambered or tilted position. Thus, the first ear cup assembly 104 shown in the behind-head configuration of FIG. 4 is in a cambered position that is slightly rotated about the first coupling axis 114 (alternatively described as a first secondary axis) in a clockwise direction relative to the position of the first ear cup assembly when the headphone assembly is in the over-head position of FIG. 1 (when viewed from the perspective shown in FIGS. 1 and 4). Conversely, when the headphone assembly 100 is in the behind-head position of FIG. 4, the second ear cup assembly 106 is in a cambered position that is slightly rotated about the second coupling axis 116 (alternatively described as a second secondary axis) in a counter-clockwise direction relative to the position of the first ear cup assembly when the headphone assembly is in the over-head position shown in FIG. 1 (when viewed from the perspective shown in FIGS. 1 and 4).

When the ear cup assemblies are in a cambered position such as shown in FIG. 4, the distance between the two inwardly-facing surfaces 124 and 126, and between their associated reference planes 124a, 126a, changes as a function of location or position along such surfaces or planes. As shown in FIG. 4, opposing locations at or near the centers of the inwardly-facing surfaces 124 and 126 along or near the rotational axis 110 are separated from one another by a distance D1, which may be the same as or similar to the distance D shown in FIG. 1. But since the reference planes 124a, 126a are not parallel to each other in the behind-head configuration of FIG. 4, other pairs of opposing locations or positions on such surfaces 124, 126 and planes 124a, 126a are separated by distances that are greater than or less than D1. For example, opposing locations on the surfaces 124 and 126 that are above (as viewed in FIG. 4) the rotational axis 110 are separated from one another by distances less than D1, with a minimum separation distance D2 occurring between uppermost (as viewed in FIG. 4) opposing locations on the inwardly-facing surfaces 124 and 126 as shown. In contrast, opposing locations on the inwardly-facing surfaces 124 and 126 that are below (as viewed in FIG. 4) the rotational axis 110 are separated from one another by distances greater than D1, with a maximum separation distance D3 occurring between lowermost (as viewed in FIG. 4) opposing locations on the inwardly-facing surfaces 124 and 126 as shown. In cases where the ear cup assemblies 104 and 106 are symmetrical above and below their central axes (such as the central axis 162 of FIGS. 10A and 10D), D3−D1=D1−D2.

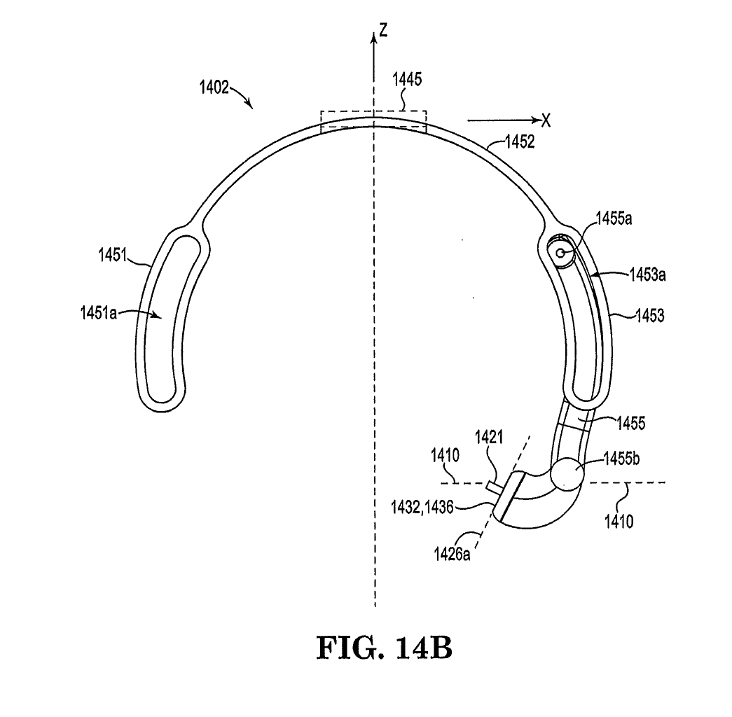

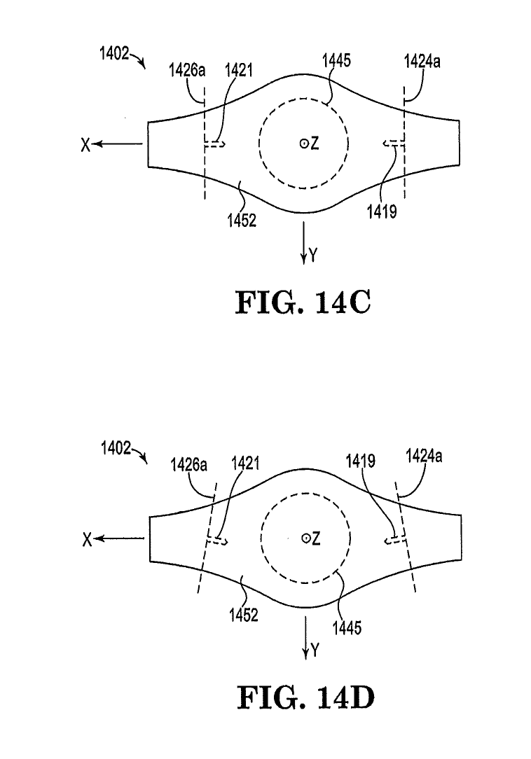

One purpose of the features that produce the self-induced cambering of the ear cup assemblies 104, 106 is to change the spring force exerted by the ear cup assemblies against the user's head, or the spatial distribution of such spring force against the user's head, by adjusting the distance (for example, from the distance D of FIG. 1 to the distance D2 of FIG. 4) between the ear cup assemblies, or between particular portions of the ear cup assemblies, as the headband assembly articulates in a particular manner, e.g., pivotally (as seen by comparing FIGS. 1 and 4), or extensibly (as seen by comparing FIGS. 14A and 14B below), or both. Such operation causes the ear cup assemblies 104, 106 to maintain an appropriate force and force distribution relative to the user's head 200 as the headband assembly 102 is in differing positions. Each ear cup assembly changes its angle of orientation by utilizing the range of articulating motion of the headband assembly, in order to maintain forces exerted by the ear cup assemblies against the head that are gentle enough (weak enough) to provide a comfortable experience for a user wearing the headphone assembly with the headband assembly in the behind-head position (e.g., as shown in FIGS. 4 and 5), but strong enough that the user does not feel as if the headphone assembly 100 will slide off of the user's head.

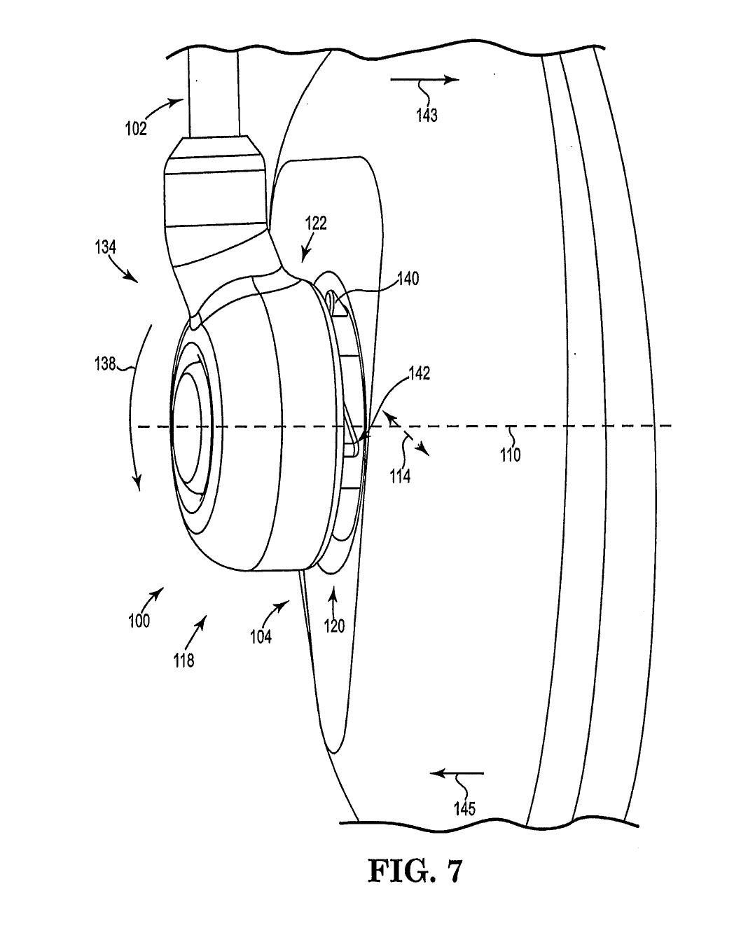

In the present embodiment, cambering of the first and second ear cup assemblies 104, 106 relative to the headband assembly 102 respectively is achieved by way of first and second coupling mechanisms 118 and 128, respectively. Cambering of the first ear cup assembly 104 occurs by way of the first coupling mechanism 118, which includes a first ear cup attachment mechanism 120 of the first ear cup assembly and a first headband attachment mechanism 122 provided on a first end 134 of the headband assembly 102. Cambering of the second ear cup assembly 106 occurs by way of the second coupling mechanism 128, which includes a second ear cup attachment mechanism 130 of the second ear cup assembly and a second headband attachment mechanism 132 provided on a second end 136 of the headband assembly 102. Each of the headband attachment mechanisms 122, 132 may include an endpiece or member having an offset shape as illustrated in FIGS. 1 and 7 to provide a clearance space or gap between the arms of the headband assembly and the respective ear cup assemblies.

To further illustrate one manner in which this cambering of the ear cup assemblies 104, 106 can occur, FIG. 7 is provided to show a right side perspective cutaway view of a portion of the headphone assembly 100 of FIGS. 1-6. The view of FIG. 7 shows the first end 134 of the headband assembly 102, the first ear cup assembly 104, and the first coupling mechanism 118, which links the headband assembly and the first ear cup assembly. The first coupling mechanism 118 is made up of, or includes, the first ear cup attachment mechanism 120 and the first headband attachment mechanism 122. As shown, the headband assembly 102 can be rotated relative to the first ear cup assembly 104, and an arrow 138 shows a direction of rotation or articulation of the headband assembly relative to the first ear cup assembly about the rotational axis 110 that occurs when the headphone assembly 100 is being adjusted from the over-head position or configuration (as shown in FIG. 7) to the behind-head position or configuration.

Also as shown in FIG. 7, the first ear cup attachment mechanism 120 includes a post feature (or post formation or post) 140, and the first headband attachment mechanism 122 includes a ramp feature (or ramp formation or ramp) 142. The reader will understand that, although not shown in FIG. 7, the second ear cup attachment mechanism 130 and the second headband attachment mechanism 132 of the second coupling mechanism 128 include a corresponding post and a corresponding ramp, respectively. As will be appreciated from the relative positions of the post 140 and ramp 142, when the headband assembly 102 is rotated relative to the first ear cup assembly 104 in accordance with the arrow 138, eventually the post and ramp come into contact with one another. When this occurs, the first ear cup assembly 104 cambers (rotates) in a clockwise direction about the first coupling axis 114, which in turn causes the upper (as viewed in FIG. 7) edge of the first ear cup assembly to move inward toward the second ear cup assembly (not shown) in the direction of an arrow 143. Conversely, this rotation causes the lower (as viewed in FIG. 7) edge of the first ear cup assembly 104 to move outward away from the second ear cup assembly (not shown) in the direction of an arrow 145 (which is opposite the direction of arrow 143). Also as will be appreciated from the relative positions of the post 140 and ramp 142, when the headband assembly 102 is rotated relative to the first ear cup assembly 104 in a direction opposite that of the arrow 138, when the headphone assembly 100 is being adjusted from the behind-head position to the over-head position, an opposite operation will occur. That is, during such operation, eventually the post 140 and ramp 142 will cease being in contact with one another. When this occurs, the formerly-cambered first ear cup assembly 104 as shown in FIG. 4 will return to the uncambered position shown in FIG. 1. Such returning of the first ear cup assembly 104 to the uncambered position will also be assisted by the natural pressure or force applied to the first ear cup assembly by the head 200 of the user relative to the headphone assembly 100 and the headband assembly 102, which as discussed below, may include or constitute a leaf spring.

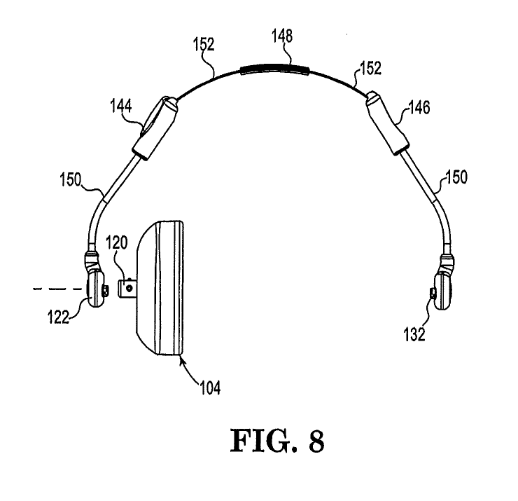

Returning of the first ear cup assembly 104 to the uncambered position can also be assisted by a spring coupling of the first ear cup assembly to the headband assembly 102, which spring coupling can be provided as part of the first coupling mechanism 118. Further, notwithstanding the above description of cambering achieved by way of the post 140 and ramp 142, which serve to provide a cam surface, the present disclosure also encompasses other known mechanisms and features that provide cambering movements of the ear cup assemblies 104, 106 relative to the headband assembly 102, or relative to certain portions of the headband assembly such as the opposed arms thereof (see e.g. elements 150, 122, and 132 in FIG. 8 below).

The first and second coupling mechanisms 118, 128 serve as ear cup attachment components by which the first and second ear cup assemblies 104, 106 can be readily attached to, and detached from, the headband assembly 102 e.g. by hand without the need for any specialized tools. Such mechanisms 118, 128 can take any of a variety of forms depending upon the embodiment. Each of the coupling mechanisms 118, 128 may for example be made up of, or may include, mechanical components such as a ratchet-type interface, or a ball-and-socket joint, the coupling mechanisms may also or instead include magnets or magnetic elements, and may provide coupling of the ear cup assemblies to the headband assembly 102 by way of magnetic forces instead of, or in addition to, mechanical forces. Also, in the present embodiment, the coupling mechanisms 118, 128 provide continuous electrical connection between the headband assembly 102 and the ear cup assemblies 104, 106 as the headband assembly articulates pivotally or extensibly (or both) over its range of motion, for example, pivotal motion relative to the ear cup assemblies between the over-head position and the behind-head position.

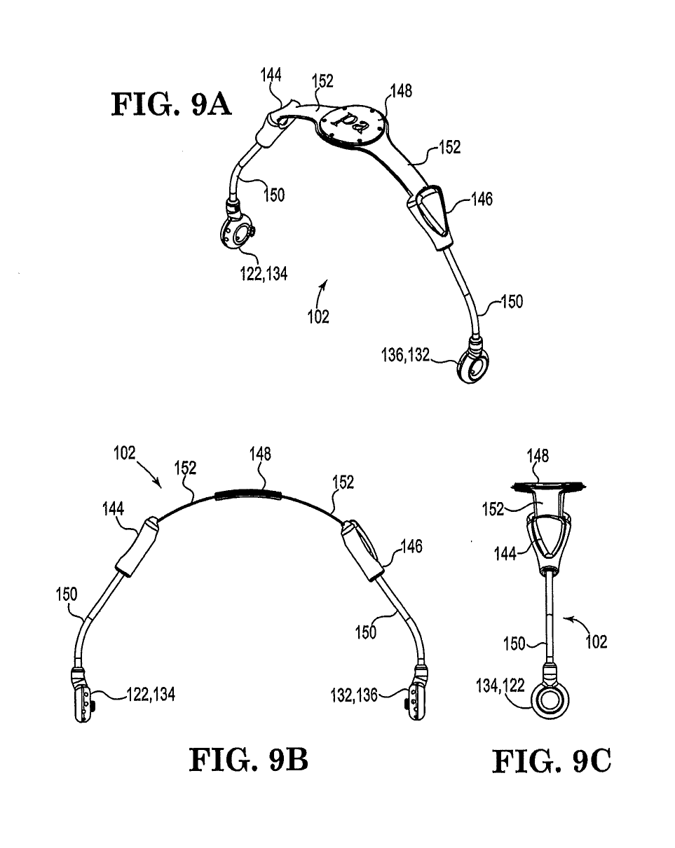

Referring next to FIG. 8, the first and second ear cup assemblies 104, 106 can preferably be fully and readily removed or detached from the headband assembly 102, preferably by hand without the need for any specialized tools, and replaced by other ear cup assemblies. This may be accomplished by incorporating quick disconnect mechanical and electrical couplings in the first and second coupling mechanisms, including for example male-female electrical connector pairs. FIG. 8 shows an exploded front elevation view of the headphone assembly 100 of FIGS. 1-7, with the first ear cup assembly 104 of the headphone assembly shown to be exploded or completely detached from the headband assembly 102, and the second ear cup assembly 106 of the headphone assembly also detached and completely removed from the headband assembly, and not shown. FIGS. 9A, 9B, and 9C are top perspective, front elevation, and right side elevation views, respectively, of the headband assembly 102 of the headphone assembly 100 of FIGS. 1-8, with both of the ear cup assemblies 104, 106 detached and removed.

To facilitate a headphone system in which the first and second ear cup assemblies 104, 106 can be fully detached, removed, and replaced, the headband assembly 102 can include components and elements such as those shown in FIGS. 9A, 9B, and 9C. These include the first and second headband attachment mechanisms 122 and 132, an electronics section 144 at which is situated main electronics and a user interface (at a user interface location), and a battery section 146 that can be considered a main rechargeable battery location, and which is adapted to receive one or more batteries, for example, rechargeable batteries. The components of the headband assembly 102 can also include an inductive coil section 148 that can be considered an inductive coil location at which is positioned an inductive coil or coils, and wiring conduits 150. The headband assembly 102 may also include portions 152 extending between the electronics section 144 and the inductive coil section 148 as well as between the inductive coil section and the battery section 146. The portions 152 are bands that may be partly or entirely elastic leaf springs that tend to maintain the shape of the headband assembly 102, and can create a compressive force against the head 200 of a user when the headphone assembly is worn by the user. In at least some cases, the portions 152 can also serve as cushions and wire aiders.

The first and second headband attachment mechanisms 122 and 132 provide electromechanical attachment of the first and second ear cup assemblies 104 and 106 to the headband assembly 102. That is, the first and second headband attachment mechanisms 122 and 132 provide mechanical coupling of the ear cup assemblies 104 and 106, respectively, to the headband assembly 102 (by virtue also of the first and second ear cup attachment mechanisms 120 and 130, respectively), and they also provide electrical coupling of the ear cup assemblies to the headband assembly, and in particular to the electronics section 144 which resides in or on the headband. To achieve mechanical coupling, the first and second headband offset attachment mechanisms 122 and 132 can include a mechanical attachment mechanism such as a “ratchet” mechanism, or a magnetic attachment mechanism, or a combination of these and/or other attachment mechanisms, methodologies, or features. Also, each of the first and second headband offset attachment mechanisms 122 and 132 may include features such as the post 140 that cause the first and second ear cup assemblies 104 and 106 to rotate and camber (or “tilt in”) as the headband assembly 102 articulates pivotally or extensibly (or both) over its range of motion, for example, transversing through its range of motion relative to the ear cup assemblies.

As for electrical coupling, the first and second headband attachment mechanisms 122 and 132 are configured to provide conductive pathways along which electrical signals can pass from the electronics section 144, through the first and second ear cup attachment mechanisms 120 and 130, and into the first and second ear cup assemblies 104 and 106, respectively, by way of wires, wiring harnesses, or other electrically conductive pathways or channels that is or are carried in the wiring conduits 150. One or both of the headband attachment mechanisms 122, 132, can also be configured to permit hard wire(s) (not shown) to be attached, to allow for wired use of the headband assembly 102 rather than, or in addition to, wireless operation. Quick disconnect electrical couplings, such as male/female multi-pin electrical connectors or connector pairs, are preferably provided in the headband attachment mechanisms 122, 132 and the ear cup attachment mechanisms 120, 130, to support electronic communication between the electronics section 144 (in the headband assembly 102) and the first and second ear cup assemblies 104 and 106, while also allowing for easy detachment and replacement of one or both of the ear cup assemblies.

The first and second headband attachment mechanisms 122 and 132 include electrically conductive pathways for electrical signals to be communicated from the headband assembly 102 to the first and second ear cup assemblies 104 and 106 so as to transmit unidirectional signals to each of the ear cup assemblies and drive one or more transducers (e.g., speakers) within those ear cup assemblies. In some cases, the first and second headband attachment mechanisms 122 and 132 also allow for electrical signals to be communicated between the headband assembly 102 and the first and second ear cup assemblies 104 and 106 bi-directionally. Such bi-directional communications can be of particular significance for embodiments in which further electrical components or technology is included in one or both ear cup assemblies 104 and 106 in addition to the aforementioned transducers, such as for example Wi-Fi circuitry, Active Noise Cancellation (ANC) technology, one or more microphones, and so forth.

The wiring conduits 150 may house not only wiring or wiring harnesses used for electrical communications between the headband assembly 102 and the ear cup assemblies 104, 106, but may also house wiring or wiring harnesses for use in the headband assembly 102. Such wiring or wire harnesses may allow electrical power to pass within and traverse the headband assembly and sections thereof, including the electronics section 144, the battery section 146, and the inductive coil section 148.

The electronics section 144, at which may be situated main electronics and a user interface (and which can be considered a main electronics and user interface holder), may also house an electronic printed circuit board assembly (PCBA) configured e.g. with an antenna to generate a wireless (e.g. Bluetooth™) data connection. The PCBA may also be configured to manage the headphone assembly 100 for wired use, or added technology that can be maintained in the ear cup assemblies 104, 106. The electronics section 144 can also be used to house, or can include, a “wired” charging cord attachment such as a micro universal serial bus (micro USB) port or an Apple™ Lightning cable port or adapter port (as is available from Apple Inc., of Cupertino, Calif.).

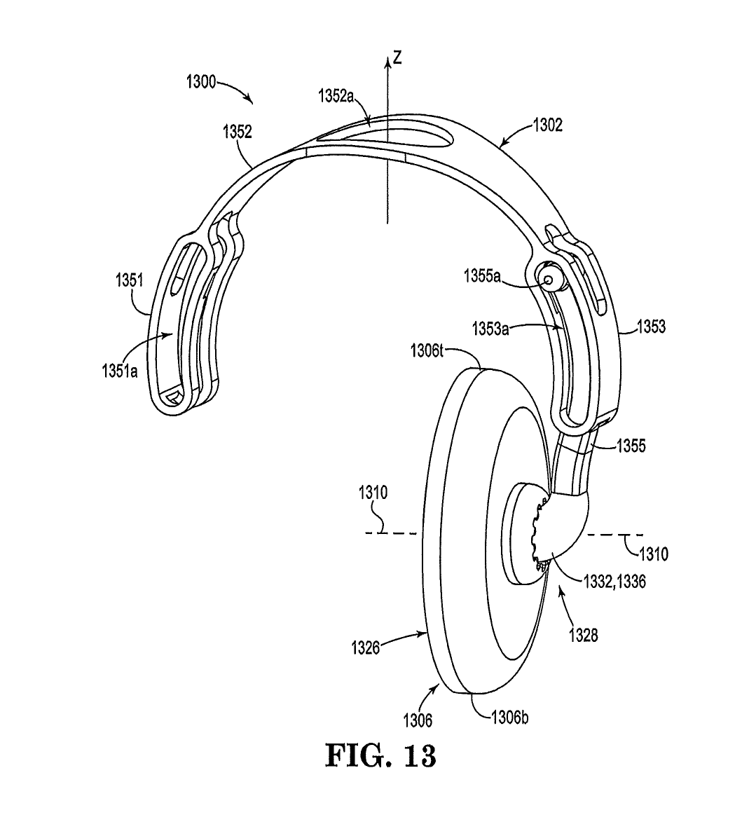

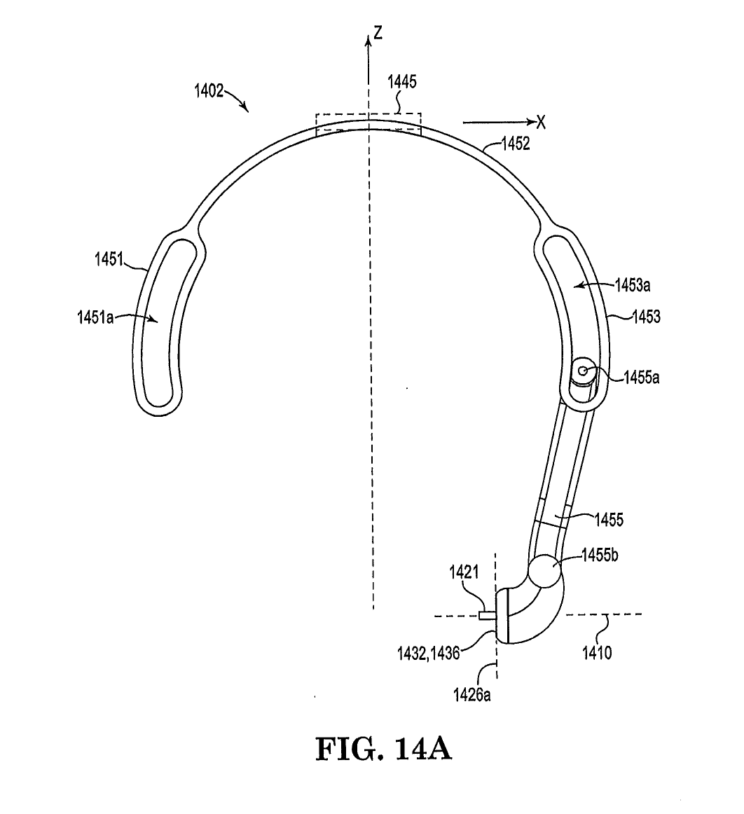

The location of the electronics section 144 is along the headband assembly 102 approximately midway between the middle of the headband assembly (at which is positioned the inductive coil section 148) and the first end 134 at which is positioned the first headband attachment mechanism 122, although other arrangements and designs are also contemplated (see e.g. FIGS. 13, 14A, and 17 below). This location of the electronics section 144 is suitable to allow for wiring to be branched into different areas of the headphone assembly 100, and also is suitable as a convenient user interface location for a user interface that is actuatable by a user to provide commands related to powering the headphone assembly 100 on or off, causing the volume levels at the ear cup assemblies 104 or 106 to go up or down, causing a changing of tracks being played on a wireless remote source such as a Bluetooth™ source, or taking other actions.

The battery section 146, provides a main rechargeable battery location that includes or serves as a repository for one or more rechargeable lithium polymer batteries or other types of batteries, including batteries with battery technologies still in development, and batteries that may arise in the future. The battery section 146 can also be a battery charging location, and can include one or more components that allow for recharging of the one or more batteries present at the battery section. As shown in FIGS. 9A and 9B, the location of the battery section 146 is along the headband assembly 102 approximately midway between the middle of the headband assembly (at which is positioned the inductive coil section 148) and the second end 136 at which is positioned the second headband attachment mechanism 132, although other arrangements and designs are also contemplated as discussed below. This location can also allow for the wiring to be branched into different areas of the headphone assembly 100 as well as facilitate providing of a user interface location suitable for receiving commands such as, but not limited to, power on/off, volume up/down, changing of tracks playing on a wireless remote source such as a Bluetooth™ source, etc.

The inductive coil section 148 serves as an inductive coil location, and includes or serves as a repository for an inductive coil. By providing the inductive coil section 148 with such an inductive coil, the inductive coil can enter into inductive communications with an inductive charging stand (not shown) so as to receive electromagnetic energy that can be used to wirelessly charge the headband assembly and the one or more batteries provided in the battery section 146. Placing the inductive coil section 148 at the top or middle of the headband assembly as shown in FIG. 8 can allow for wiring to be branched into different areas of the headphone assembly 100 as well as to facilitate providing of a user interface location suitable for receiving commands such as, but not limited to, power on/off, volume up/down, changing of tracks playing on a wireless remote source such as a Bluetooth™ source, etc.

Each of the first and second ear cup assemblies 104 and 106 is preferably readily detachable from the headband assembly 102, and can be considered a detachable ear cup assembly. Referring now also to FIGS. 10A, 10B, 10C, 10D, and 10E, respectively, top plan, top perspective, left side elevation, rear elevation, and right side elevation views, respectively, are provided of the first ear cup assembly 104 to show the features of such a detachable ear cup assembly in more detail. Although FIGS. 10A, 10B, 10C, 10D, and 10E depict the first ear cup assembly 104, the reader will understand that the second ear cup assembly 106 can have the same or similar features, for example, the second ear cup assembly may have the same components, and features that are the same as, or mirror images of, those shown in FIGS. 10A, 10B, 10C, 10D, and 10E.

Referring to FIGS. 10A, 10B, 10C, 10D, and 10E, the first (detachable) ear cup assembly 104 includes a cup portion 154, an inner transducer holder 156, an ear plate assembly 158, and the first ear cup attachment mechanism 120 mentioned above. The cup portion 154 can be constructed out of any suitable materials, including for example wood, plastic, or metal, and includes an outer surface 160 that is opposite the first inwardly-facing surface 124 of the first ear cup assembly 104. The cup portion 154 is configured to allow for both the inner transducer holder 156 and the first ear cup attachment mechanism 120 to be mounted to it. The cup portion 154 (or other portions of the first ear cup assembly 104) can also support, or become a mounting part for, other electronics, via a printed circuit board, or other types of technology. Such other electronics can include (but are not limited to) Wi-Fi chipsets, microphones, inductive charging circuitry, etc., and also can include advanced electronics as such electronics become available via technological upgrades. As discussed further below, the cup portion 154 (or other portions of the first ear cup assembly 104) may also include features allowing for an ear plate assembly to function and allowing for cord management.

The inner transducer holder 156 is configured to allow for mounting of a transducer or speaker element, as well as appropriate electrical connections for driving the transducer or speaker element, on the first ear cup assembly 104. The electrical connections can be made with respect to the first ear cup attachment mechanism 120, which facilitates attachment of the first ear cup assembly 104 to the headband assembly 102, and can relatedly allow for electrical connections between the first ear cup assembly 104 and the headband assembly 102. Also, the inner transducer holder 156 may include features that allow for the ear plate assembly 158 to be mounted to, or disassembled from, the inner transducer holder. Although for purposes of this description the transducer or speaker element is considered a component that is distinct from the first ear cup assembly 104, the transducer or speaker element can also be considered a part of the first ear cup assembly.

The first ear cup attachment mechanism 120 is or includes a protrusion that extends outward from the outer surface 160 of the cup portion 154 that is opposite the inner transducer holder 156 (which can be considered as constituting, or constituting part of, an inner surface of the cup portion 154), along the central axis 162 of the first ear cup assembly 104. As described above, the first ear cup attachment mechanism 120 is configured to mate with or couple to the first headband attachment mechanism 122, and to allow for both rotation of the headband assembly 102 relative to the first ear cup assembly 104 (e.g., rotation about the rotational axis 110) as well as cambering or pivoting of the first ear cup assembly 104 relative to the headband assembly (e.g., about the first coupling axis 114).

The first ear cup attachment mechanism 120 not only is a mechanical attachment component, but also allows for one, some, or numerous electrical connections to be made simultaneously from the electronics section 144, located in or on the headband assembly, to the contents of the first ear cup assembly 104, including to the transducer, with such electrical connections in turn allowing for driving of the transducer and/or, in at least some embodiments, to other electrical devices located in or on the first ear cup assembly 104, including electrical devices in accordance with new or future technology. The first ear cup attachment mechanism 120 may also be configured to maintain electrical connections between the first ear cup assembly 104 and the headband assembly 102 notwithstanding the pivotal or extensible articulation of the headband assembly (e.g. to various angular positions or to various degrees of extension or retraction, as discussed below), such that the headband assembly 102 can articulate relative to the first ear cup assembly 104 and at the same time remain in electrical communication with the first ear cup assembly at all positions and times.

The ear plate assembly 158 allows for an ear cushion (not shown) to be mounted to the first ear cup assembly 104. The ear plate assembly 158 may in fact not only allow for a single ear cushion to be supported on the first ear cup assembly 104, but may allow for a given ear cushion to be replaced with any of a variety of other ear cushions. Further, the ear plate assembly 158 also includes features that allow for the ear plate assembly to be mounted to or disassembled from the inner transducer holder 156.

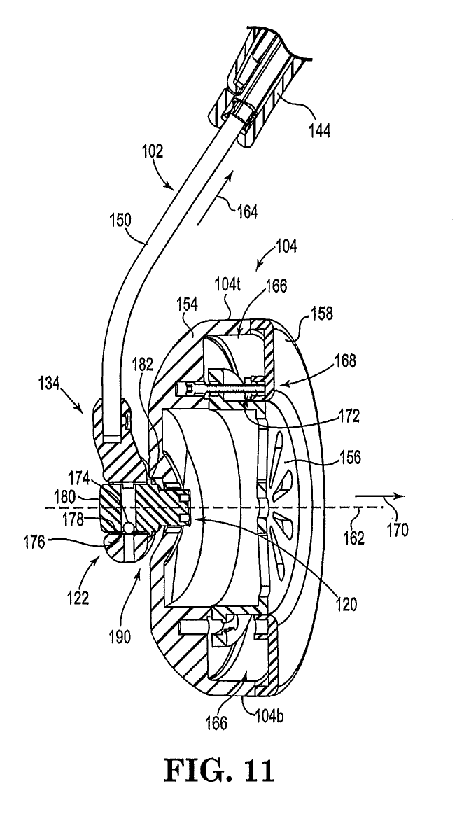

Turning to FIG. 11, a partly perspective, cutaway, cross-sectional view of a portion of the headphone assembly 100 including the first ear cup assembly 104 is provided, in order to further illustrate several features of the headband assembly 102 and the first ear cup assembly. FIG. 11 shows, for example, how the headband assembly 102 can be adjusted in its size or length (e.g., the length between the first and second ends 134 and 136, or between the first and second headband attachment mechanisms 122 and 132) insofar as a position of the wiring conduit 150 relative to the electronics section 144 can be adjusted. The wiring conduit 150 by itself, or in combination with the first end 134, can be considered to form a first arm of the headband assembly 102, opposite to a (mirror image) second arm. As illustrated by arrow 164, the wiring conduit 150 can be slid inward into the electronics section 144 or into another portion of the headband. Further, if the wiring conduit 150 has already been slid partly or substantially inward into the electronics section 144, the wiring conduit 150 can also be slid outward from the electronics section in a direction opposite to that of the arrow 164.

The sliding of the wiring conduit 150 relative to the electronics section 144 can be facilitated by a spring (not shown in FIG. 11) positioned within the electronics section, and also can occur as sliding of the wiring conduit along a region of a PCBA within the electronics section. Further, the wiring conduit 150 on the opposite side of the headband assembly 102 (not shown in FIG. 11), which connects to the battery section 146, can, in the same or substantially similar manner, be slid inward into or outward from the battery section as well, so as to shorten or lengthen the headband assembly 102.

FIG. 11 also illustrates in more detail the interrelationship between the ear plate assembly (or ear plate) 158, the cup portion 154, and the inner transducer holder 156, and shows how the ear plate assembly 158 can include features that allow the ear plate assembly to be mounted to, or disassembled from, the cup portion and inner transducer holder. More particularly in this respect, the ear plate assembly 158 is configured so that the ear plate assembly can move away from the remainder of the first ear cup assembly 104, and away from the cup portion 154 and the inner transducer holder 156 (e.g., outward from the remainder of the first ear cup assembly or inward away from the first ear cup attachment mechanism 120), in a direction illustrated by arrow 170.

When the ear plate assembly 158 is moved in this manner, there is exposed an annular region 166 within which one or more electric wires or cords (not shown) can be wound, and which can be considered a cord management or storage region. That is, the ear plate assembly 158 can be pulled out from the base of the ear cup assembly 104 formed by the cup portion 154 and inner transducer holder 156, so as to expose a pocket for cords to be stored, where the cords that are stored can for example include one for use as a wired headphone and another for use in charging the headband assembly 102. It will be appreciated from FIG. 11 that the annular region 166 is formed between the cup portion 154 (which forms the annular region's outer boundary) and the inner transducer holder 156 (which forms the annular region's inner boundary) and that the wires or cords, when stored within the annular region 166, are wound around the inner transducer holder 156.

Also in the present embodiment, the ear plate assembly 158 additionally includes a ⅛^{th} turn (one-eighth-turn) or ¼ turn (quarter-turn) locking feature 168 that interfaces or engages a complementary feature 172 associated with the ear cup portion 154 (and/or the inner transducer holder 156). The interaction between the locking feature 168 and complementary feature 172 determines whether the ear plate assembly 158 can be removed from the remainder of the first ear cup assembly 104. That is, when the ear plate assembly 158 is in a first rotational position relative to the remainder of the first ear cup assembly 104 (including the cup portion 154 and inner transducer holder 156), the ear plate assembly is fastened to the remainder of the first ear cup assembly due to the interfacing of the locking feature 168 and complementary feature 172. However, after the ear plate assembly 158 is rotated a ⅛^{th} or ¼ turn about the central axis 162 of the first ear cup assembly 104, the ear plate assembly 158 can be moved in the direction of the arrow 170 (which is parallel to the central axis 162) and removed from the remainder of the first ear cup assembly 104.

When the ear plate assembly 158 is removed completely in this manner, the annular region 166 is exposed such that any wires or cords within the annular region can be removed therefrom or, alternatively, wires or cords can be wound around the inner transducer holder 156 within the annular region 166 and thereby fit into and stored within that annular region. In at least some embodiments, a magnetized cord for wired playback feature can also be present in the first headband offset attachment mechanism 122 that further facilitates wire retraction. That is, the headband assembly 102 can include a magnetized set of electrical connections for a specialized cord for wired use. Additionally, when the ear plate assembly 158 is removed, any ear cushion previously provided on the first ear cup assembly 104 can be easily removed and changed or replaced with an alternative ear cushion (not shown).

FIG. 11 also illustrates the first ear cup attachment mechanism 120 in relation to the first headband attachment mechanism 122 in more detail. In the embodiment shown, the first ear cup attachment mechanism 120 includes a ratchet tooth 182 that is configured to engage complementary regions on the first headband attachment mechanism 122 so as to tend to limit the rotational positioning or articulation of the headband assembly 102 relative to the first ear cup assembly 104 to particular discrete rest positions. The first ear cup attachment mechanism 120 also includes a spring-biased ball 174 along its outer periphery that can fit within a receiving socket 176 formed within an inner surface 178 of the first headband offset attachment mechanism 122. The ball and socket mechanism that is formed by the spring-biased ball 174 and receiving socket 176 allows for the first ear cup attachment mechanism 120 to be axially locked in place relative to the headband assembly 102 when the ball and socket are aligned, so as to restrict or preclude movement of the first ear cup assembly 104 in the direction of the arrow 170.

Notwithstanding the locking function of the ball and socket mechanism, the locking in place of the first ear cup assembly 104 relative to the headband assembly 102 can be overcome and the first ear cup assembly can be removed from the headband assembly if pressure is placed (e.g., by a user's finger) upon an outwardly-facing button 180 positioned at or proximate to the first end 134 of the headband assembly 102. The outwardly-facing button 180 can be an extension of the first ear cup attachment mechanism 120 itself that extends through the first headband attachment mechanism 122 or a part of the first headband attachment mechanism that interfaces the first ear cup attachment mechanism. Regardless of which type of arrangement is present, when sufficient pressure is placed upon the outwardly-facing button 180 in the direction of the arrow 170, the spring-biased ball 174 will be dislodged from the receiving socket 176 such that the first ear cup assembly 104 can be fully disassembled from the headband assembly 102.

As discussed above, the first ear cup attachment mechanism 120 and first headband attachment mechanism 122 may include several features that allow for or facilitate electrical connections between the first ear cup assembly 104 and the headband assembly 102. For example, a pivot point 190 of the first coupling mechanism 118 (encompassing the first ear cup attachment mechanism 120 and the first headband attachment mechanism 122) may have 2-6 (at least two to six) electrical connections that allow for the appropriate electrical linkages and communications between the headband assembly 102 and the transducer (speaker element) of the first ear cup assembly 104 to be established and maintained. Quick disconnect electrical connectors, such as male/female multi-pin electrical connectors or connector pairs, or other suitable electrical connectors, may be used for this purpose. By virtue of these electrical connections, electrical signals for driving the transducer can be received at the transducer from the headband assembly 102. The first ear cup attachment mechanism 120 of the first ear cup assembly 104 may in this regard include electrical receiving connections for the headband assembly 102 that allow the transducer to be driven by the headband assembly.

Given the above-described operation of the first headband attachment mechanism 122 and first ear cup attachment mechanism 120, the reader will appreciate that the first ear cup assembly 104 can not only be removed or detached from the headband assembly 102 (as can the second ear cup assembly 106, in the same or similar manner), but also the first ear cup assembly can be replaced with an alternative ear cup assembly that is similarly configured to engage with or couple to the first headband attachment mechanism 122. Indeed, the headband assembly 102 is configured so as to be able to receive and engage with any of a variety of different ear cup assemblies or ear cups, so long as those different ear cup assemblies or ear cups also have ear cup attachment mechanisms that are the same as or similar to the first ear cup attachment mechanism 120 in terms of being configured for interfacing and coupling with the first headband attachment mechanism 122.

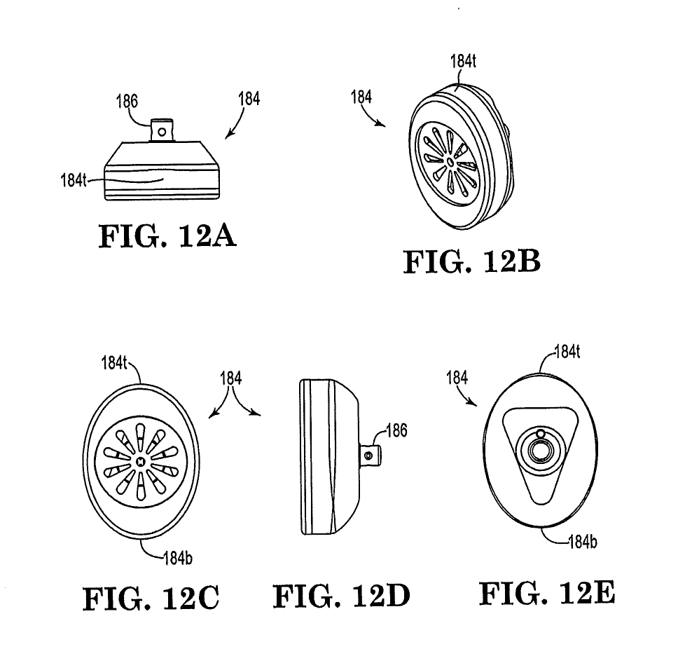

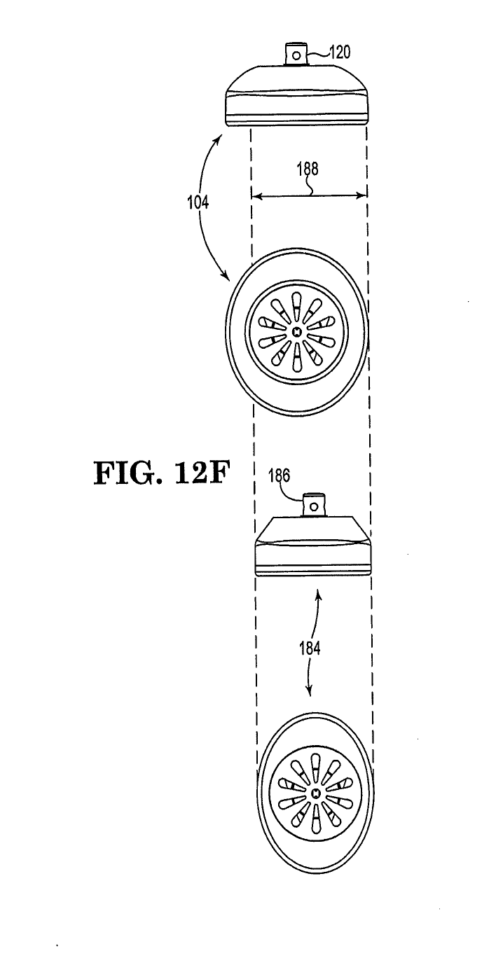

For example in this regard, FIGS. 12A, 12B, 12C, 12D, and 12E show top plan, top perspective, left side elevation, rear elevation, and right side elevation views, respectively, of an alternate embodiment of a third ear cup assembly 184 that can be utilized in conjunction with the headband assembly 102 in place of the first ear cup assembly 104. As is evident from a comparison of FIG. 12A with FIG. 10A, FIG. 12B with FIG. 10B, FIG. 12C with FIG. 10C, FIG. 12D with FIG. 10D, and FIG. 12E with FIG. 10E, the third ear cup assembly 184 includes several components and features that are the same as or similar to those of the first ear cup assembly 104. In particular, the third ear cup assembly 184 includes a third ear cup attachment mechanism 186 that is identical to the first ear cup attachment mechanism 120, such that the third ear cup assembly 184 can fit into and be supported in relation to the first headband attachment mechanism 122 in the same manner as the first ear cup assembly 104. The third ear cup assembly 184 has a top 184t and a bottom 184b, which correspond substantially to the top and bottom 104t, 104b of the first ear cup assembly 104. The third ear cup assembly 184 can also be understood to include a cup portion, inner transducer holder, and ear plate assembly that are the same as or similar to the above-described cup portion 154, inner transducer holder 156, and ear plate assembly 158, respectively. However, as illustrated by additional FIG. 12F showing the relative sizes of the first ear cup assembly 104 and third ear cup assembly 184, the third ear cup assembly 184 is smaller than the first ear cup assembly 104, in terms of a width or minor dimension of the cup assemblies as viewed along an axis 188.

Thus, the headphone assembly 100 can be modified repeatedly by easily (e.g. by hand) replacing ear cup assemblies with other ear cup assemblies in relation to the same headband assembly 102. The present disclosure contemplates the use of detachable ear cup assemblies in relation to the base headband assembly 102, and contemplates that any given ear cup assembly or ear cup can be substituted or changed out with smaller, larger, newer, or otherwise different (e.g., different in terms of materials or technology implemented) ear cup assemblies or ear cups. Among other things, the electrical connections provided on the headband assembly 102 are intended to allow for a variety of types of ear cup assemblies having a variety of types of electrical features to be coupled to and operated in relation to the headband assembly.

Although a single, simple conventional transducer on an ear cup assembly can be operated with merely two of these electrical connections, the headband assembly 102 may be configured to account for the possibility of changes or leaps in technology in the future by virtue of which additional technology or technical components will be resident in an ear cup assembly that can be used as a substitute for the first ear cup assembly 104. By providing additional electrical connections on the headband assembly 102, such a substitute or replacement ear cup assembly having additional technology or technical components can still be attached to the headband assembly 102, since the additional electrical connections will allow for power, ground, and additional signal connections between the headband assembly 102 and the substitute ear cup assembly. Such additional technology or technical components within the ear cup assembly can include active noise cancellation features, such that the ear cup assembly can be a noise cancellation ear cup assembly (or cup). Further, in some such cases, the headband system (e.g., within the electronics section) can house internal microphone(s) for either noise cancellation, or voice, or both.

The reader will appreciate that embodiments of disclosed headphone assemblies and components thereof can achieve one or more of a variety of advantages. In at least some cases, the headband assembly (e.g., the headband assembly 102) can pivotally articulate over a wide angular range between an upright or over-head position and a behind-head position (e.g., a wide range from a zero degree level corresponding to the over-head position, from the cup center, to past a 90 degree level corresponding to the behind-head position), so as to provide some relief for the user from “headphone fatigue”. Further, in at least some cases, as this pivotal articulation of the headband assembly happens (and as the headband assembly is articulated or rotated relative to the ear cup assemblies of the headphone assembly), a cam mechanism or other mechanism can cause the ear cup assemblies (or ear cups) to camber. In at least some cases, this can be performed in a manner in which the mechanical moments are modified while maintaining the appropriate forces of the ear cup assemblies on the user's head.

Furthermore, in at least some cases, the electronics section and the power pack (e.g., battery section) can be positioned in the headband assembly (e.g., the headband assembly 102) of the headphone assembly. By virtue of such an arrangement, the ear cup assemblies (or ear cups) of the headphone assembly can be replaceable and interchangeable with other ear cup assemblies (or ear cups), where the different ear cup assemblies (or ear cups) can differ in any of a number of respects including the materials employed in the ear cup assemblies, the sizes of the ear cup assemblies, and/or the technical features that are implemented within the ear cup assemblies (or ear cups), including future or enhanced technological features such as miniaturized electronics features that are increasingly prevalent in the wireless audio world.

Further, in at least some cases, such as in embodiments wherein the electronics section and power pack (battery section) are positioned at locations along the headband assembly rather than in the ear cup assemblies (or ear cups), space within the ear cup assemblies is freed up and available for other components or purposes including, in at least some such embodiments, cord management or ear cushion replacement/change. Also, in at least some cases, inductive (wireless) charging components can be positioned in the headband assembly to allow power to be supplied to the headphone assembly wirelessly from an external location or “mat” or other source, with such power then being available for recharging batteries on the headphone assembly or for other uses.

Additionally, in at least some cases, the headphone assembly may include combinations of the disclosed features, including a pivotally or extensibly articulating headband, a mechanism that causes the cups to camber during and in a completed articulation to maintain the appropriate forces on the user's head as the spring in the headband assembly (in relation to a user's head) changes its moment, and appropriate connectivity between the ear cup assemblies and the transducers (or speaker elements) therein to receive at least two electrical connections allowing for signals to be provided to the transducers to drive the transducers.

The behavior and fitment of the disclosed headphone assemblies can also be conveniently and easily adjusted or modified by users, and such embodiments constitute a much broader base product that is capable of fitting many different sizes of heads of users. Indeed, by having replaceable or interchangeable ear cups and ear cushions, it is possible for users to modify their existing base product to fit or support many different applications or address many different situations. In other words, a user (or a group of users) can buy a single headband assembly with wireless distribution built into it, and those users can then modify or change the ear cup assemblies (or ear cups) to suit their particular needs or desires. For example, a user can replace ear cup assemblies with other ear cup assemblies to achieve changes in cup size, cup shape, or cup material (which can also affect, for example, the weight of the ear cups), and/or to arrive at desired over-ear, on-ear, ovular, round, or other ear cup assemblies, and/or to implement any of a variety of other types of ear cup assemblies with any of a variety of other features. Additionally, given that the same headband assembly can be fitted with numerous different types of ear cup assemblies (ear cups), at least some such headphone assemblies not only facilitate fitment but also allow for ear cup assemblies (ear cups) with future-developed or enhanced technology features to be implemented as part of the headphone assembly.

Notwithstanding the above description of various embodiments of headphone assemblies and components thereof (and associated methods of operation and assembly thereof), the present disclosure encompasses numerous variations of the above-described embodiments, and numerous other embodiments of headphone assemblies and components thereof (and associated methods of operation and assembly thereof) in addition to those described above. For example, notwithstanding the description of the post 140 and ramp 142 above, in other embodiments the relative positioning of the post and ramp can be modified from that shown (or reversed, such that the post is on the first headband offset attachment mechanism and the ramp is on the first ear cup attachment mechanism), and/or other cam-type features can be provided to achieve cambering.

Also, it should be appreciated that, to the extent one or more features are described in detail above in relation to one side of the headphone assembly, but are not described in detail in relation to the other side of the headphone assembly, it is intended that the present disclosure encompasses embodiments that have the same or substantially the same features (or mirror images of such features) on both sides of the headphone assembly. For example in this regard, to the extent the above description concerns various features of the first ear cup assembly 104, it should be understood that, even if corresponding features of the second ear cup assembly 106 are not described in detail above, the present disclosure encompasses embodiments in which the above-described features of the first ear cup assembly 104 are also present or substantially present (either in identical form or in a mirror image form) in the second ear cup assembly 106.

### Further Discussion

More headphone assemblies, components thereof, and other features in accordance with the foregoing description will now be discussed. A headphone assembly 1300 is shown in FIG. 13. The headphone assembly 1300 has a headband assembly 1302 to which are attached a first ear cup assembly (omitted from the drawing for simplicity) and an opposed second ear cup assembly 1306, designed to fit over a user's ears.

Just as with the headphone assembly 100 described above, the headphone assembly 1300 is preferably designed for high fidelity stereo listening, with separate and distinct right (R) and left (L) audio channel signals directed from active electronics in the electronics section (discussed further below) to the first and second ear cup assemblies, respectively. A rotational axis 1310, similar to or the same as the rotational axis 110 above, extends between center points of the first and second opposed ear cup assemblies, only one of which is shown in FIG. 13. A z-axis is also included in FIG. 13 to represent a centrally or symmetrically located longitudinal axis defined by one or both of the headband assembly 1302 and the headphone assembly 1300. The z-axis may lie in a plane analogous to plane 108 above, in which the headband assembly 1302 resides, or along which the headband assembly 1302 extends.

Like the headband assembly 102 described above, the headband assembly 1302 has a main headband body 1352 from which a first arm (not shown in FIG. 13) and a second thin 1355 extend from opposite ends of the main body 1352. The first arm may be the same as, or a mirror image of, the second arm 1355. The main body 1352 is generally C-shaped, e.g. so that it fits snugly over, or at least approximates the shape of, the top part of a user's head. The main body 1352 is preferably made of plastic, metal, or other suitable materials, and it may be or comprise one or more leaf springs.

The main headband body 1352 includes guide members 1351, 1353 as shown, located at or near the ends of the body 1352. Each of the two guide members is shaped and adapted to receive the corresponding arm of the headband assembly in a slidable fashion, such that the headphone assembly 1300 can be contracted (made smaller) by retracting the arms into the guide members, or expanded (made bigger) by extending the arms such that most of each arm is withdrawn from its associated guide member. The arm 1355, for example, has a barrel 1355a at one end of the arm which engages a slot 1353a of the guide member 1353. The first guide member 1351 may have a substantially similar slot 1351a for use with the first arm (not shown in FIG. 13). By this or other similar mechanisms, the first and second arms may slidingly engage the main headband body to provide extensible articulation of the headband assembly between an extended configuration and a retracted configuration.

If desired, cambering features can optionally be employed in the headband assembly 1302, or in the two ear cup assemblies, or in both, to cause (1) the inwardly-facing surface of the first ear cup assembly, or a first headband attachment mechanism, to change its orientation relative to the first arm in response to the extensible articulation, and (2) the inwardly-facing surface of the second ear cup assembly, or a second headband attachment mechanism, to change its orientation relative to the second arm in response to the extensible articulation. The cambering features may be the same as or similar to the post 140 and ramp 142 discussed above, or they may be substantially different. Cambering of the (second) ear cup assembly 1306 may occur by way of a coupling mechanism 1328, which may be the same as or similar to coupling mechanisms discussed above, and may include a second ear cup attachment mechanism of the second ear cup assembly and a second headband attachment mechanism 1332 provided on a second end 1336 of the headband assembly 1302. Cambering of the first ear cup assembly (not shown in FIG. 13) is preferably substantially the same (e.g. a mirror image counterpart) to the cambering of the second ear cup assembly 1306. The cambering features may designed such that a rotation of the headband assembly relative to rotational axis 1310 extending through one or both of the ear cup assemblies causes the given ear cup assembly to rotate about a secondary axis that is at least substantially perpendicular to the rotational axis 1306, in an analogous manner to the discussion above. Cambering features may alternatively or additionally be designed such that extensible articulation of the headphone assembly—by extending or retracting the arms from or into the main headband body 1352—produces a self-induced rotation or reorientation of each ear cup assembly (or reference plane corresponding to the inwardly-facing surface) relative to its associated arm.

A hole 1352a, or a cavity or compartment, may be provided in the main headband body 1352 to accommodate one or more of an electronics section, a battery section, and an inductive coil coupling section. Such electronics, battery, and inductive coil coupling sections may be the same as or similar to those discussed above, but they may be combined into a single section or compartment located in, at, or near the hole 1352a. The hole, cavity, or compartment may be centrally placed at the top or middle of the main body 1352 as shown, with the z-axis passing through its center, or the hole (or other holes, cavities, or compartments) may be placed off-center. Electronic audio signals and other electrical signals can be routed from microprocessor(s), amplifier(s), or other active electronics disposed in the electronics section to transducers or other electrical components disposed in the ear cup assemblies by suitable wires or wiring harnesses that pass through and along the arms of the headband assembly, preferably also including multi-pin electrical connectors at the first and second coupling mechanisms to allow for easy detachment and replacement of the ear cup assemblies.

The ear cup assembly 1306 may be the same as or similar to any of the ear cup assemblies discussed above, including for example ear cup assemblies 106 or 104 of FIG. 1. Thus, the ear cup assembly 1306 includes an inwardly-facing surface 1326 having a major transverse dimension aligned with a top 1306t and bottom 1306b of the ear cup assembly 1306, and a minor transverse dimension typically perpendicular to the major dimension. The ear cup assembly 1306 also preferably includes an ear cup attachment mechanism adapted to releasably mate with the headband attachment mechanism 1332

Cambering as a function of extensible articulation of a headphone assembly is demonstrated in the context of another headband assembly 1402 in FIGS. 14A through 14D. The headband assembly 1402 may be substantially the same as or similar to the headband assembly 1302 described above. Thus, the headband assembly 1402 has a main headband body 1452 from which a first arm (not shown in FIG. 14A) and a second arm 1455 extend from opposite ends of the main body 1452. The first arm may be the same as, or a mirror image of, the second arm 1455. The main headband body 1452 is generally C-shaped, and includes guide members 1451, 1453 as shown, located at or near the ends of the body 1452. Each of the two guide members is shaped and adapted to receive the corresponding arm of the headband assembly in a slidable fashion, such that the headphone assembly (of which the headband assembly 1402 is a part) can be contracted by retracting the arms into the guide members, or expanded by extending the arms.

A rotational axis 1410, similar to or the same as the rotational axis 1310 above, extends between center points of the first and second opposed ear cup assemblies (not shown in FIG. 14A). A Cartesian xyz coordinate system is included in FIGS. 14A-D for reference purposes, the coordinate system being fixed with respect to the headband assembly. The z-axis is a centrally or symmetrically located longitudinal axis defined by the headband assembly 1402. The z-axis and the x-axis form an x-z plane analogous to plane 108 above. That is, the headband assembly 1402 resides in, or extends along, the x-z plane. Other planes, labeled 1424a and 1426a, are provided to schematically represent reference planes associated with the inwardly-facing surfaces of the first and second ear cup assemblies, respectively, when such ear cup assemblies are installed on or attached to the ends of the headband assembly 1403.

The second arm 1455 has a barrel 1455a at one end thereof which engages a slot 1453a of the guide member 1453. The first guide member 1451 has a substantially similar slot 1451a for use with the first arm. The first and second arms thus slidingly engage the main headband body to provide extensible articulation of the headband assembly between an extended configuration and a retracted configuration. At the opposite (or distal) end of the second arm 1455, which coincides with a second end 1436 of the headband assembly 1402, a second headband attachment mechanism 1432 is provided. The second headband attachment mechanism 1432, as well as a first headband attachment mechanism on the first arm, is preferably configured to releasably mate with a corresponding ear cup attachment mechanism, which attachment mechanisms may incorporate quick disconnect mechanical and electrical couplings, including for example male-female electrical connector pairs. One such electrical connector (e.g. a male multi-pin electrical connector, made to mate with a female multi-pin electrical connector in the second ear cup attachment mechanism of the second ear cup assembly), which forms part of the second headband attachment mechanism 1432, is labeled 1421. Another such electrical connector, which forms part of the first headband attachment mechanism, is labeled 1419 (see FIGS. 14C and 14D).

The second arm 1455 also has a pivot joint 1455b provided therein near the distal end of the arm, to allow such distal end (coinciding also with the second end 1436 of the headband assembly) to rotate or otherwise change its orientation relative to other elements of the headband assembly 1402, e.g., relative to the arm 1455, or at least the portion thereof between the barrel 1455a and the pivot joint 1455b. The rotation provided by the pivot joint 1455b is relative to a secondary axis that is perpendicular to the axis 1410. In alternative embodiments, the pivot joint may be incorporated inside the distal end of the arm 1455, such that for example only the second headband attachment mechanism 1432, and no part of the arm 1455, rotates about such secondary axis. Rotation of the pivot joint 1455b may be directly mechanically linked to the translational motion of the barrel 1455a within and along the slot 1453a, such that a given nonzero amount of rotation occurs at the joint 1455a in response to a given nonzero amount of travel of the barrel 1455a along the slot 1453a. Such a direct mechanical linkage may be provided using known mechanical elements configured to function as cambering features, such as one or more of cables, springs, gears, cantilevers, drums, and bearings. In a simple embodiment, a tensioned cable or a semi-rigid, toothed band anchored on the main headband body 1452 can extend through an aperture in the barrel 1455a, and through most of the (hollow) second arm 1455 up to the pivot joint 1455b, where such cable or band wraps around or otherwise engages a rotating drum, or a gear mechanically coupled to such a drum, to thus convert the translational motion to rotational motion.

Extension or retraction of a given arm relative to the main headband body 1452 may be achieved by simple hand manipulation by the user. In FIGS. 14A and 14C, the arms are fully or substantially fully extended, while in FIGS. 14B and 14D, the arms are fully or substantially fully retracted. The fully extended arrangement is suitable for an over-head position of the headphones (of which the headband assembly 1402 is a part) on the user's head (see e.g. FIGS. 2 and 3), while the fully retracted arrangement is suitable for a behind-head position of such headphones on the user's head (see e.g. FIGS. 4 and 5). Intermediate arrangements and positions, i.e., part way between the over-head and behind-head positions, are of course also contemplated.

The view of FIG. 14A, assuming the headphones are worn by the user (not shown) in an over-head position, involves a front elevation view of the user, where the user directly faces the reader, e.g. as shown in FIG. 2. The view of FIG. 14C, again assuming an over-head position, involves a top plan view of the user, where the user faces the negative y-direction. In these figures, the reference planes 1424a, 1426a can be seen to be approximately parallel to, and equidistant from, each other.

In contrast, the view of FIG. 14B, assuming the headphones are worn by the user (not shown) in a behind-head position, involves a top plan view of the user, where the user faces the negative z-direction. The view of FIG. 14D, again assuming a behind-head position, involves a rear elevation view of the user, where the user faces the negative z-direction. In these figures, the reference planes 1424a, 1426a can be seen to be substantially non-parallel to each other, and thus closer to each other at the top of the user's ears than at the bottom of the user's ears when in the behind-head position. Such a cambering-induced rotation of the ear cup assemblies helps the headphones to stay on the user's head when worn in a behind-head or similar position, while maintaining a comfortable fit.

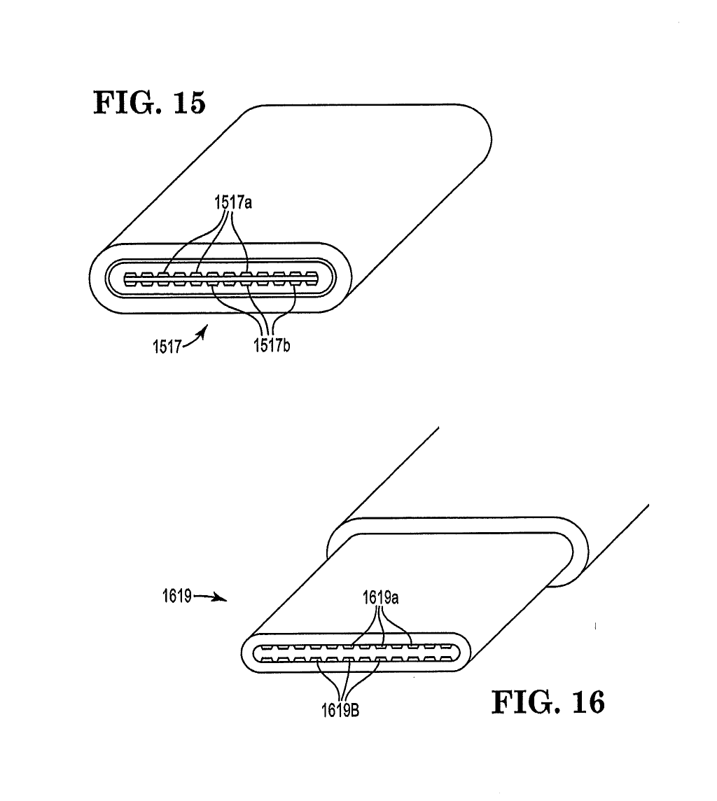

Turning now to FIGS. 15 and 16, we see there perspective views of an exemplary female multi-pin electrical connector 1517 and male multi-pin electrical connector 1619. Such electrical connectors may be suitable for providing quick disconnect electrical couplings in the disclosed headphone assemblies. For example, the male connector 1619 may be included in each of the first and second headband attachment mechanisms, while the female connector 1517 may be included in each of the first and second ear cup attachment mechanisms, or vice versa. When the two connectors 1517, 1619 are mated, corresponding conductive pins make electrical contact, and establish electrical continuity along multiple electrically isolated conductive paths (when supplemented by suitable wires or wiring harnesses as needed) between transducer(s) and other electronic components in the ear cup assemblies, and microprocessor(s), amplifier(s), and other electronic components in the electronics section of the headband assembly. As is apparent from the figures, mating of the connectors causes conductive pins or contacts 1619a in the male connector make contact with pins 1517a in the female connector, and pins 1619b to make contact with pins 1517b. The 24-pin embodiment shown may be in accordance with USB Type C electrical connector standards. In such a case, mating or coupling can also be achieved with reversed orientations of the connectors 1517, 1619, such that pins 1619a in the male connector make contact with pins 1517b in the female connector, and pins 1619b make contact with pins 1517a. The headphone assembly, and the electronics section, may be configured and wired with redundant paths such that the headphones can operate regardless of how the connectors are mated, e.g., whether reversed or non-reversed.

Of course, other known multi-pin electrical connectors, with other numbers of pins or contacts, and in other designs, can also be used. The electrical connectors may be non-rotationally symmetric (e.g. as in FIGS. 15 and 16), or they may be rotationally symmetric. Non-rotationally symmetric connectors often accommodate more conductive pins or contacts than rotationally symmetric connectors, and in that regard may be more desirable from the standpoint of upgrading to ear cup assemblies that contain numerous electronic components or transducers. In some cases, the mated electrical connectors by themselves may provide sufficient mechanical support or stability between the headband assembly and a given ear cup assembly that no separate mechanical coupling is required. In other cases, additional mechanical components or features, e.g. to provide a separate (detachable) mechanical connection or coupling, may be desirable or necessary. In cases where rotational motion is desired (e.g. about a rotational axis such as axis 110 of FIG. 1) between the ear cup assemblies and the headband assembly, rotationally symmetric electrical connectors can be employed to allow for such rotation, or wires can be used with sufficient extra length or slack to accommodate the rotation of one of the electrical connectors relative to the headband assembly or the ear cup assembly between the rotational endpoints or limits.

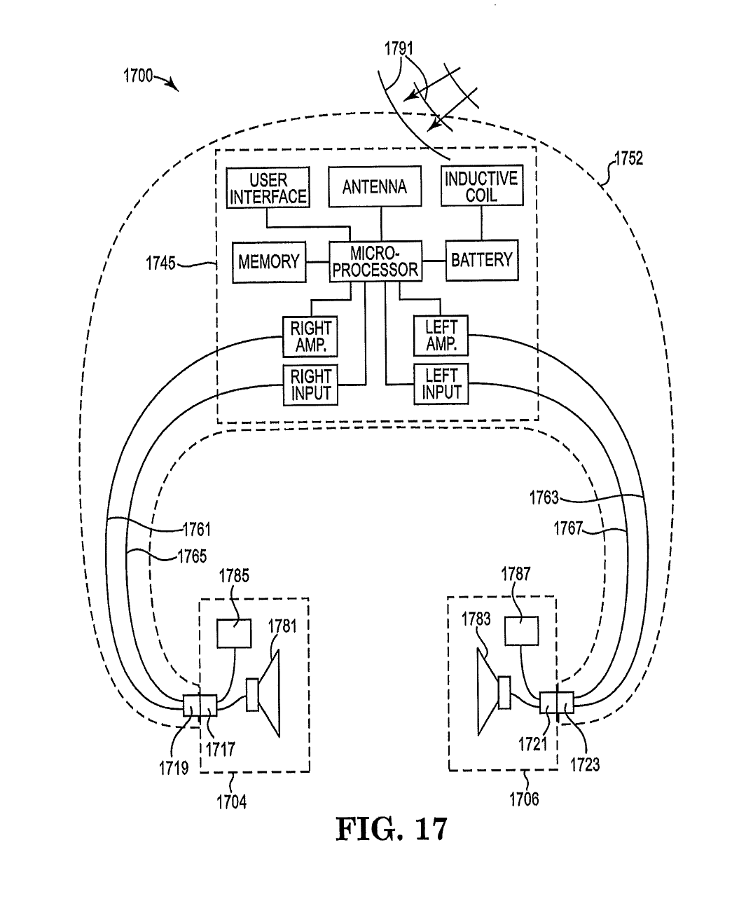

FIG. 17 shows a system block diagram of a headphone assembly 1700 and illustrative subassemblies and components thereof, the function and interaction of which can be readily understood and appreciated in light of the preceding detailed description. The headphone assembly 1700, and components thereof, may thus represent any one or more of the headphone assemblies, and components thereof, discussed herein. The headphone assembly 1700 therefore includes a headband assembly 1752, a first ear cup assembly 1704, and a second ear cup assembly 1706. The ear cup assemblies may be configured to rotate and camber relative to the headband assembly 1752, and may be detachably connected to the headband assembly. The headband assembly may adapted to pivotally or extensibly articulate over a range of motion.

The ear cup assemblies typically include at least one transducer (speaker), but may include other transducers or electronic components, e.g., other speakers, microphones, push buttons or other user interfaces, input jacks, and active electronics. Ear cup assembly 1704 includes a transducer (speaker) 1781 and such other optional electronic components 1785. These elements attach to wires which in turn attach to an electrical connector 1717, such as a quick disconnect multi-pin electrical connector. Similarly, ear cup assembly 1706 includes a transducer (speaker) 1783 and other optional electronic components 1787, as discussed. These elements attach to wires which in turn attach to an electrical connector 1721, such as a quick disconnect multi-pin electrical connector. The ear cup assemblies 1704, 1706 couple and communicate electronically (via the wires) with active electronics in the headband assembly 1752.

The headband assembly 1752 includes a section, compartment, or module 1745 that may incorporate one, some, or all of the electronics sections, battery sections, and inductive coil sections discussed above, as well as other suitable electronic components. The module 1745 may receive wireless signals 1791 (e.g. via a Bluetooth™ connection) via an antenna, and process and separate the signals into at least a right (R) and left (L) channel. A microprocessor, coupled to or including a memory module, and right and left amplifiers may be used for this purpose. A given amplifier typically produces an output that is increased in amplitude relative to its input, but in some cases the amplifier may be a follower amplifier with unit (1.0) amplification, and in other cases the output of the amplifier may have a decreased signal amplitude. The resulting right and left audio drive signals are then transmitted via wires 1761, 1763 through respective first and second arms of the headband assembly, through respective electrical connector pairs 1719/1717 and 1723/1721, and finally to the respective transducers 1781, 1783 to produce sound for the enjoyment of the user. To the extent the ear cup assemblies include other electronic components 1785, 1787, such components can receive signals (including electrical power) from, or send signals to, the module 1745 via the same electrical connector pairs and the wire(s) 1765, 1767.

The module 1745 may also include an inductive coil coupled to a rechargeable battery. The inductive coil is configured to wirelessly mate with an inductive charging stand when the headphone system is not otherwise in use, to charge the battery. Alternative, other conventional charging technology may be employed in the module 1745, or the battery may simply be non-rechargeable. In any case, the battery (or batteries) connect to the microprocessor (if present) and other active electronics that require electrical power to operate.

The module may also include a right and left input circuit to receive electronic signals from electronic components in the ear cup assemblies, and communicate such signals to the microprocessor, if present. Finally, the module 1745 may include one or more user interfaces, as discussed herein, and communicate the status of such user interface(s) to the microprocessor.

### Items Disclosed

This document discloses numerous headphone-related systems, components, features, and methods, including but not limited to the following items:

Item 1. A headphone assembly comprising:
a headband assembly having first and second end portions;
first and second ear cup assemblies respectively coupled at least indirectly to the first and second end portions, respectively,
wherein one or more of the end portions and ear cup assemblies includes one or more cambering features, and
wherein, due to the cambering features, a first rotation of the headband assembly relative to a rotational axis extending through one or both of the ear cup assemblies causes the first ear cup assembly to rotate further about a secondary axis that is at least substantially perpendicular to the rotational axis.

Item 2. The headphone assembly of item 1, wherein the cambering features include a post formation and a ramp formation.

Item 3. The headphone assembly of item 2, wherein the first ear cup assembly includes one of the post formation and the ramp formation as part of a first ear cup attachment mechanism of the first ear cup assembly, wherein the first end portion of the headband assembly includes the other of the post formation and the ramp formation as part of a first headband offset attachment mechanism.

Item 4. The headphone assembly of item 3, wherein at least one of the first ear cup attachment mechanism and the first headband offset attachment mechanism includes an electrical connection feature by which an electrical signal can be provided from the headband assembly to the first ear cup assembly so as to drive a transducer of the first ear cup assembly.

Item 5. The headphone assembly of item 1, wherein the rotational axis extends through centers of each of the first and second ear cup assemblies, wherein the first rotation of the headband assembly relative to the rotational axis also is relative to the first and second ear cup assemblies, and wherein, due to the cambering features, the first rotation causes the second ear cup assembly to rotate about a tertiary axis that is at least substantially perpendicular to the rotational axis.

Item 6. The headphone assembly of item 5, wherein the first and second ear cup assemblies respectively are caused to rotate about the secondary axis and tertiary axis in opposite directions respectively such that first and second opposed portions of the first and second ear cup assemblies move toward one another.

Item 7. The headphone assembly of item 6, wherein the first rotation of the headband assembly involves an articulation of the headband assembly at least substantially ninety degrees, between a behind-head position and an over-head position.

Item 8. A headphone assembly comprising:
a headband assembly including:
   an electronics section;
   a battery section; and
   first and second headband offset attachment mechanisms;
a first ear cup assembly having a first ear cup attachment mechanism by which the first ear cup assembly is coupled to the first headband offset attachment mechanism; and
a second ear cup assembly having a second ear cup attachment mechanism by which the second ear cup assembly is coupled to the second headband offset attachment mechanism,
wherein the first and second ear cup attachment mechanisms and first and second headband offset attachment mechanisms are configured so as to allow each of the first and second ear cup assemblies to be disassembled from the headband assembly and thereby allow for first and second replacement cup assemblies to be coupled to the headband assembly in place of the first and second ear cup assemblies.

Item 9. The headphone assembly of item 8, wherein each of the first and second ear cup attachment mechanisms and each of the first and second headband offset attachment mechanisms includes at least one electrical connection feature by which one or more signals can be provided from the headband assembly to the first and second ear cup assemblies, so that the signals can directly or indirectly drive transducers provided on the first and second ear cup assemblies.

Item 10. The headphone assembly of item 9, wherein the at least one electrical connection feature of the first and second headband offset attachment mechanisms is configured to allow for one or more additional electrical components other than transducers and wiring of the replacement cup assemblies to enter into communications with the headband assembly when the replacement cup assemblies are coupled to the headband assembly.

Item 11. The headphone assembly of item 8, wherein the first ear cup attachment mechanism and the first headband offset attachment mechanism form a first coupling mechanism, wherein the second ear cup attachment mechanism and the second headband offset attachment mechanism form a second coupling mechanism, wherein the first and second coupling mechanisms respectively include first and second ball and socket mechanisms, and wherein the first and second ball and socket mechanisms respectively govern retention of the first ear cup assembly in relation to the headband assembly and of the second ear cup assembly in relation to the headband assembly, respectively.

Item 12. The headphone assembly of item 8, wherein the headband assembly additionally includes an inductive coil coupling section.

Item 13. The headphone assembly of item 8, wherein all or substantially all electrical components of the headphone assembly are provided on the headband assembly, excepting transducers, wiring, and electrical connection features that are provided on the first and second ear cup assemblies.

Item 14. The headphone assembly of item 13, wherein the first ear cup assembly includes an ear plate that can be removed from a remainder of the first ear cup assembly.

Item 15. The headphone assembly of item 14 wherein, when the ear plate is removed from the remainder of the first ear cup assembly, an annular region within the first ear cup assembly is exposed into which can be positioned, or from which can be removed, an electrical wire or cord.

Item 16. The headphone assembly of item 8, wherein the first ear cup assembly includes an ear plate that can be removed from a remainder of the first ear cup assembly and wherein, when the ear plate is removed from the remainder of the first ear cup assembly, an annular region within the first ear cup assembly is exposed into which can be positioned, or from which can be removed, an electrical wire or cord.

Item 17. The headphone assembly of item 16 wherein, when the ear plate is removed from the remainder of the first ear cup assembly, a first cushion associated with the first ear cup assembly can be removed from the first ear cup assembly and a second cushion can be substituted for the first cushion in relation to the first ear cup assembly.

Item 18. The headphone assembly of item 8, wherein the first replacement cup assembly has one or more of a different size, shape, material composition, or electrical component layout by comparison with the first ear cup assembly.

Item 19. A headband assembly for implementation in a headphone assembly, the headband assembly comprising:
an electronics section;
a battery section; and
first and second headband offset attachment mechanisms,
wherein the first headband offset attachment mechanism is configured to allow a plurality of first ear cup assemblies to be interchangeably coupled to the headband assembly, and
wherein the second headband offset attachment mechanism is configured to allow a plurality of second ear cup assemblies to be interchangeably coupled to the headband assembly.

Item 20. The headband assembly of item 19, further including an inductive coil coupling section, and wherein a length of the headband assembly can be adjusted due to relative sliding of portions of the headband assembly relative to one or both of the electronics section and the battery section.

Item 1a. A headband assembly for use in a headphone, the headband assembly comprising:
an electronics section;
a battery section electrically coupled to the electronics section;
a first headband attachment mechanism disposed at a first end of the headband assembly; and
a second headband attachment mechanism disposed at a second end of the headband assembly, the second end being opposed to the first end of the headband assembly;
wherein each of the first and second headband attachment mechanisms is configured to detachably connect to an ear cup assembly and provide an electrical connection from the ear cup assembly to the electronics section.

Item 2a. The headband assembly of item 1a, wherein the electronics section includes one or more electronic components, the one or more electronic components including at least one of a microprocessor, an amplifier, and an antenna.

Item 3a. The headband assembly of item 2a, wherein the battery section is wired to energize at least one of the one or more electronic components when a suitable battery is present in the battery section.

Item 4a. The headband assembly of item 1a, wherein the electronics section and the battery section are disposed in separate compartments on or in the headband assembly.

Item 5a. The headband assembly of item 1a, wherein the electronics section and the battery section are disposed in a same compartment on or in the headband assembly.

Item 6a. The headband assembly of item 1a, wherein the first headband attachment mechanism includes a first male or female multi-pin electrical connector, and the second headband attachment mechanism includes a second male or female multi-pin electrical connector.

Item 7a. The headband assembly of item 1a, wherein the headband assembly includes a C-shaped main headband body and a first and second arm extending from opposite ends of the main headband body, the main headband body including the electronics section and the battery section, the first arm including the first headband attachment mechanism, the second arm including the second headband attachment mechanism, the headband assembly further comprising:
one or more first cambering features that cause the first headband attachment mechanism to change its orientation relative to the first arm in response to pivotal or extensible articulation of the headband assembly over a range of motion; and
one or more second cambering features that cause the second headband attachment mechanism to change its orientation relative to the second arm in response to the pivotal or extensible articulation of the headband assembly over the range of motion.

Item 8a. The headband assembly of item 7a, wherein a rotational axis passes through the first and second headband attachment mechanisms, and wherein the one or more first cambering features cause the first headband attachment mechanism to rotate about a first secondary axis in response to pivotal articulation of the headband assembly about the rotational axis, and the one or more second cambering features cause the second headband attachment mechanism to rotate about a second secondary axis in response to the pivotal articulation of the headband assembly, the first and second secondary axes each being perpendicular to the rotational axis.

Item 9a. The headband assembly of item 7a, wherein the first and second arms slidingly engage the main headband body to provide extensible articulation of the headband assembly between an extended configuration and a retracted configuration, and wherein the one or more first cambering features cause the first headband attachment mechanism to change its orientation relative to the first arm in response to the extensible articulation, and the one or more second cambering features cause the second headband attachment mechanism to change its orientation relative to the second arm in response to the extensible articulation.

Item 10a. A headphone assembly, comprising:
the headband assembly of item 1a;
a first ear cup assembly detachably connected to the first headband attachment mechanism; and
a second ear cup assembly detachably connected to the second headband attachment mechanism.

Item 11a. The headphone assembly of item 10a, wherein the first headband attachment mechanism includes a first male or female multi-pin electrical connector, and the first ear cup assembly includes a first female or male multi-pin electrical connector that reversibly mates with the first male or female multi-pin electrical connector.

Item 12a. A headphone assembly, comprising:
a headband assembly including:
   an electronics section;
   a battery section electrically coupled to the electronics section; and
   a first and second headband attachment mechanism;
a first ear cup assembly having a first ear cup attachment mechanism adapted to reversibly mate with the first headband attachment mechanism to mechanically and electrically connect the first ear cup assembly to the headband assembly; and
a second ear cup assembly having a second ear cup attachment mechanism adapted to reversibly mate with the second headband attachment mechanism to mechanically and electrically connect the second ear cup assembly to the headband assembly.

Item 13a. The headphone assembly of item 12a, wherein the first and second ear cup assemblies rotationally engage the headband assembly to provide rotational articulation of the headband assembly over a rotational range of motion from an over-head configuration to a behind-head configuration.

Item 14a. The headphone assembly of item 12a, wherein the headband assembly includes a C-shaped main headband body and a first and second arm extending from opposite ends of the main headband body, the main headband body including the electronics section and the battery section.

Item 15a. The headphone assembly of item 14a, wherein the first and second arms slidably engage the main headband body to provide extensible articulation of the headband assembly over a translational range of motion from a fully extended configuration to a fully retracted configuration.

Item 16a. The headphone assembly of item 14a, wherein the first arm includes the first headband attachment mechanism and the second arm includes the second headband attachment mechanism, and wherein the first and second ear cup assemblies have a respective first and second inwardly-facing surface that define a respective first and second reference plane, the headband assembly further comprising:
one or more first cambering features that cause the first reference plane to change its orientation relative to the first arm in response to pivotal or extensible articulation of the headband assembly over a range of motion; and
one or more second cambering features that cause the second reference plane to change its orientation relative to the second arm in response to the pivotal or extensible articulation of the headband assembly over the range of motion.

Item 17a. The headphone assembly of item 12a, wherein the headband assembly also includes an inductive coil coupling section coupled to the battery section.

Item 18a. A headphone assembly, comprising:
a headband assembly having a first arm and a second arm arranged for placement on opposite sides of a user's head; and
a first ear cup assembly and a second ear cup assembly connected to the headband assembly by the first and second arms, respectively, the first and second ear cup assemblies having a respective first and second inwardly-facing surface that define a respective first and second reference plane;
wherein one or both of the first arm and the first ear cup assembly includes one or more first cambering features that cause the first reference plane to change its orientation relative to the first arm in response to pivotal or extensible articulation of the headband assembly over a range of motion.

Item 19a. The headphone assembly of item 18a, wherein one or both of the second arm and the second ear cup assembly includes one or more second cambering features that cause the second reference plane to change its orientation relative to the second arm in response to pivotal or extensible articulation of the headband assembly over a range of motion.

Item 20a. The headphone assembly of item 18a, wherein the one or more first cambering features cause the first reference plane to change its orientation relative to the first arm in response to pivotal articulation of the headband assembly over an angular range of motion.

Item 21a. The headphone assembly of item 18a, wherein the one or more first cambering features cause the first reference plane to change its orientation relative to the first arm in response to extensible articulation of the headband assembly over a translational range of motion.

Item 22a. The headphone assembly of item 18a, wherein the first ear cup assembly detachably connects to the first arm by a first male/female multi-pin connector pair, and the second ear cup assembly detachably connects to the second arm by a second male/female multi-pin connector pair.

The use of terms such as “vertical,” “horizontal,” “rearward,” or other orientational, directional, or relative terms herein to describe various embodiments are merely employed for convenience to facilitate the description of some embodiments herein. Notwithstanding the use of such terms, the present disclosure should not be interpreted as being limited to any particular orientations or relative positions of assemblies or components specifically described, but rather should be understood to encompass a variety of embodiments with assemblies or components having any of a variety of orientations or relative positions in addition to those described above. Further for example, although the present description envisions a headphone assembly with a headband assembly having an articulation range between over-head and behind-head positions, the present disclosure also contemplates embodiments in which the headband assembly takes other positions including, for example, positions in front of a user's head (e.g., in front of the user's forehead).

It is specifically intended that the present invention not be limited to the embodiments and illustrations contained herein, but include modified forms of those embodiments including portions of the embodiments and combinations of elements of different embodiments as come within the scope of the following claims.

What is claimed is:

1. A headband assembly for use in a headphone, the headband assembly comprising:
an electronics section;
a battery section electrically coupled to the electronics section;
a first headband attachment mechanism disposed at a first end of the headband assembly; and
a second headband attachment mechanism disposed at a second end of the headband assembly, the second end being opposed to the first end of the headband assembly;
wherein each of the first and second headband attachment mechanisms is configured to detachably connect to an ear cup assembly and provide an electrical connection from the ear cup assembly to the electronics section.

2. The headband assembly of claim 1, wherein the electronics section includes one or more electronic components, the one or more electronic components including at least one of a microprocessor, an amplifier, and an antenna.

3. The headband assembly of claim 2, wherein the battery section is wired to energize at least one of the one or more electronic components when a suitable battery is present in the battery section.

4. The headband assembly of claim 1, wherein the electronics section and the battery section are disposed in separate compartments on or in the headband assembly.

5. The headband assembly of claim 1, wherein the electronics section and the battery section are disposed in a same compartment on or in the headband assembly.

6. The headband assembly of claim 1, wherein the first headband attachment mechanism includes a first male or female multi-pin electrical connector, and the second headband attachment mechanism includes a second male or female multi-pin electrical connector.

7. The headband assembly of claim 1, wherein the headband assembly includes a C-shaped main headband body and a first and second arm extending from opposite ends of the main headband body, the main headband body including the electronics section and the battery section, the first arm including the first headband attachment mechanism, the second arm including the second headband attachment mechanism, the headband assembly further comprising:
one or more first cambering features that cause the first headband attachment mechanism to change its orientation relative to the first arm in response to pivotal or extensible articulation of the headband assembly over a range of motion; and
one or more second cambering features that cause the second headband attachment mechanism to change its orientation relative to the second arm in response to the pivotal or extensible articulation of the headband assembly over the range of motion.

8. The headband assembly of claim 7, wherein a rotational axis passes through the first and second headband attachment mechanisms, and wherein the one or more first cambering features cause the first headband attachment mechanism to rotate about a first secondary axis in response to pivotal articulation of the headband assembly about the rotational axis, and the one or more second cambering features cause the second headband attachment mechanism to rotate about a second secondary axis in response to the pivotal articulation of the headband assembly, the first and second secondary axes each being perpendicular to the rotational axis.

9. The headband assembly of claim 7, wherein the first and second arms slidingly engage the main headband body to provide extensible articulation of the headband assembly between an extended configuration and a retracted configuration, and wherein the one or more first cambering features cause the first headband attachment mechanism to change its orientation relative to the first arm in response to the extensible articulation, and the one or more second cambering features cause the second headband attachment mechanism to change its orientation relative to the second arm in response to the extensible articulation.

10. A headphone assembly, comprising:
the headband assembly of claim 1;
a first ear cup assembly detachably connected to the first headband attachment mechanism; and
a second ear cup assembly detachably connected to the second headband attachment mechanism.

11. The headphone assembly of claim 10, wherein the first headband attachment mechanism includes a first male or female multi-pin electrical connector, and the first ear cup assembly includes a first female or male multi-pin electrical connector that reversibly mates with the first male or female multi-pin electrical connector.

12. A headphone assembly, comprising:
a headband assembly including:
an electronics section;
a battery section electrically coupled to the electronics section; and
a first and second headband attachment mechanism;
a first ear cup assembly having a first ear cup attachment mechanism adapted to reversibly mate with the first headband attachment mechanism to mechanically and electrically connect the first ear cup assembly to the headband assembly; and
a second ear cup assembly having a second ear cup attachment mechanism adapted to reversibly mate with the second headband attachment mechanism to mechanically and electrically connect the second ear cup assembly to the headband assembly.

13. The headphone assembly of claim 12, wherein the first and second ear cup assemblies rotationally engage the headband assembly to provide rotational articulation of the headband assembly over a rotational range of motion from an over-head configuration to a behind-head configuration.

14. The headphone assembly of claim 12, wherein the headband assembly includes a C-shaped main headband body and a first and second arm extending from opposite ends of the main headband body, the main headband body including the electronics section and the battery section.

15. The headphone assembly of claim 14, wherein the first and second arms slidably engage the main headband body to provide extensible articulation of the headband assembly over a translational range of motion from a fully extended configuration to a fully retracted configuration.

16. The headphone assembly of claim 14, wherein the first arm includes the first headband attachment mechanism and the second arm includes the second headband attachment mechanism, and wherein the first and second ear cup assemblies have a respective first and second inwardly-facing surface that define a respective first and second reference plane, the headband assembly further comprising:
one or more first cambering features that cause the first reference plane to change its orientation relative to the first arm in response to pivotal or extensible articulation of the headband assembly over a range of motion; and
one or more second cambering features that cause the second reference plane to change its orientation relative to the second arm in response to the pivotal or extensible articulation of the headband assembly over the range of motion.

17. The headphone assembly of claim 12, wherein the headband assembly also includes an inductive coil coupling section coupled to the battery section.

18. A headphone assembly, comprising:
a headband assembly having a first arm and a second arm arranged for placement on opposite sides of a user's head; and
a first ear cup assembly and a second ear cup assembly connected to the headband assembly by the first and second arms, respectively, the first and second ear cup assemblies having a respective first and second inwardly-facing surface that define a respective first and second reference plane;
wherein one or both of the first arm and the first ear cup assembly includes one or more first cambering features that cause the first reference plane to change its orientation relative to the first arm in response to pivotal or extensible articulation of the headband assembly over a range of motion.

19. The headphone assembly of claim 18, wherein one or both of the second arm and the second ear cup assembly includes one or more second cambering features that cause the second reference plane to change its orientation relative to the second arm in response to pivotal or extensible articulation of the headband assembly over a range of motion.

20. The headphone assembly of claim 18, wherein the one or more first cambering features cause the first reference plane to change its orientation relative to the first arm in response to pivotal articulation of the headband assembly over an angular range of motion.

21. The headphone assembly of claim 18, wherein the one or more first cambering features cause the first reference plane to change its orientation relative to the first arm in response to extensible articulation of the headband assembly over a translational range of motion.

22. The headphone assembly of claim 18, wherein the first ear cup assembly detachably connects to the first arm by a first male/female multi-pin connector pair, and the second ear cup assembly detachably connects to the second arm by a second male/female multi-pin connector pair.
